(19) United States
(12) Patent Application Publication
(10) Pub. No.: US 2026/0279405 A1
(43) Pub. Date: Sep. 17, 2026

(54) VIDEO PROCESSING METHOD, CAMERA DEVICE, AND IMAGE PROCESSING DEVICE

(71) Applicant: ARASHI VISION INC., Shenzhen (CN)

(72) Inventors: Bolin CHEN, Shenzhen (CN); Liangqu LONG, Shenzhen (CN); Xueqin BI, Shenzhen (CN); Xiangxia ZHOU, Shenzhen (CN); Fangjin WEN, Shenzhen (CN)

(73) Assignee: ARASHI VISION INC., Shenzhen (CN)

(21) Appl. No.: 19/680,961

(22) Filed: May 18, 2026

Related U.S. Application Data
(63) Continuation of application No. PCT/CN2023/132652, filed on Nov. 20, 2023.

(51) Int. Cl. G11B 27/34; G11B 27/00; H04N 5/77

(52) U.S. Cl. CPC G11B 27/34; G11B 27/007; H04N 5/772

(57) ABSTRACT

In some aspects, the present disclosure provides a camera device. The camera device includes a camera configured to record a target video, a processor, a display coupled to the processor, and a memory in communication with the processor. The memory is configured to store computer instructions. The processor is configured to: during a recording of a target video, generate or mark at least one highlight segment of the target video; after the target video is recorded by the camera, in response to receiving a playback instruction for the target video, control the display to display a playback interface of the target video; and receive and respond to an operation instruction for the at least one highlight segment according to the playback interface.

### CROSS-REFERENCE TO RELATED APPLICATION

This application is a continuation of International Application No. PCT/CN2023/132652, filed on November 20, 2023, the content of which is hereby incorporated by reference in its entirety.

### BACKGROUND

The present disclosure relates to the technical field of video processing, and particularly relates to a video processing method, a camera device, and an image processing device.

With the development of Internet technology and the advent of the new media era, the video industry has also become one of the important fields in modern society. Video processing technology is an important part of the video production process. Through video processing technology, users can edit the original video content into the video content they want.

However, current video processing generally requires users to complete it manually, and the video processing process is relatively complex.

### SUMMARY

Based on this, it is necessary to provide a video processing method, a camera device, and an image processing device capable of automatically editing videos to address the above technical problems.

In a first aspect, the present disclosure provides a video processing method, applicable to a camera device, the method includes: during a process of recording a target video, generating or marking at least one highlight segment of the target video; after the target video is recorded, if a playback instruction for the target video is received, displaying a playback interface of the target video; and receiving and responding to an operation instruction for the highlight segment according to the playback interface.

In one implementation, the playback interface includes a highlight segment display control, and receiving and responding to an operation instruction for the highlight segment according to the playback interface includes:

if a trigger operation for the highlight segment display control is detected, displaying a highlight segment playback interface, and circularly playing the highlight segment based on the highlight segment playback interface.

In one implementation, the highlight segment display control includes quantity indication information, and the quantity indication information indicates a quantity of highlight segments in the target video.

In one implementation, the highlight segment playback interface further includes a summary information list of the highlight segment. The summary information list includes at least one summary indication control of the highlight segment. The summary indication control indicates summary information of the corresponding highlight segment, and circularly playing the highlight segment based on the highlight segment playback interface includes:

during a process of circularly playing the highlight segment based on the highlight segment playback interface, displaying the summary indication control corresponding to the currently played highlight segment based on a target display effect, and the target display effect is configured to distinguish the summary indication control of the currently played highlight segment from the summary indication controls of other highlight segments.

In one implementation, the highlight segment playback interface further includes a highlight segment export control, and the method further includes:

if a trigger operation for the highlight segment export control is detected, performing an export process on the highlight segment corresponding to the selected summary indication control.

In one implementation, if a trigger operation for the highlight segment export control is detected, performing an export process on the highlight segment corresponding to the selected summary indication control includes:

if a trigger operation for the highlight segment export control is detected, displaying an export interface, the export interface includes at least one export type control; and performing an export process on the highlight segment corresponding to the selected summary indication control according to an export type corresponding to the selected export type control.

In one implementation, the export types include a segmented export type and a merged export type; and according to the export type corresponding to the selected export type control, an export process is performed on the highlight segment corresponding to the selected summary indication control includes:

If the export type corresponding to the selected export type control is the segmented export type, performing an export process on the highlight segment corresponding to the selected summary indication control respectively; and if the export type corresponding to the selected export type control is the merged export type, merging the highlight segments corresponding to the selected summary indication control and then exporting.

In one implementation, the playback interface further includes a video play control, and the method further includes:

if a trigger operation for the video play control is detected, playing the target video, and during a process of playing the target video, displaying a playing position interval corresponding to the highlight segment in the target video on a first progress bar of the target video.

In one implementation, the playback interface further includes a highlight segment editing control, and the method further includes:

if a trigger operation for the highlight segment editing control is detected during a process of playing the target video, displaying a current playing progress of the target video in real time on a second progress bar of the target video, where the second progress bar is configured to display the playing position interval corresponding to the highlight segment in the target video, and a size of the second progress bar is greater than a size of the first progress bar.

In one implementation, a preset position of the second progress bar is provided with a play progress indication control. The play progress indication control indicates the current play progress of the target video, and the method further includes:

if the play progress indication control indicates that the current playing video segment interval is the playing position interval corresponding to the highlight segment, and a highlight segment deletion operation for the play progress indication control is detected, modifying the currently played highlight segment as a non-highlight segment; and if the play progress indication control indicates that the current playing video segment interval is not the playing position interval corresponding to the highlight segment, and a highlight segment generation operation for the play progress indication control is detected, generating a highlight segment based on the current playing position interval of the second progress bar.

In one implementation, generating a highlight segment based on the current playing position interval of the second progress bar includes:

if there is no highlight segment in the preset interval threshold of the current playing position interval of the second progress bar, generating an independent highlight segment based on the current playing position interval.

In one implementation, generating a highlight segment based on the current playing position interval of the second progress bar includes:

if there is a highlight segment in the preset interval threshold of the current playing position interval of the second progress bar, generating a merged highlight segment based on the current playing position interval and the highlight segment in the preset interval threshold, and the merged highlight segment includes the highlight segment in the preset interval threshold.

In one implementation, generating or marking at least one highlight segment of the target video during the process of recording the target video includes:

during the process of recording the target video, if a highlight segment marking operation for the target video is detected, generating or marking at least one highlight segment of the target video based on a video recording screen corresponding to the highlight segment marking operation.

In one implementation, a video recording interface of the target video includes a highlight segment marking control, and if a highlight segment marking operation for the target video is detected, generating or marking at least one highlight segment of the target video based on a video recording screen corresponding to the highlight segment marking operation includes:

if a trigger operation for the highlight segment marking control is detected, generating or marking at least one highlight segment of the target video based on a video recording screen corresponding to the trigger operation.

In one implementation, generating or marking at least one highlight segment of the target video during the process of recording the target video includes:

during the process of recording the target video, generating highlight segment analysis information of the target video; and generating or marking at least one highlight segment of the target video according to the highlight segment analysis information.

In one implementation, the method further includes:

sending the highlight segment analysis information to a terminal, so that the terminal generates the highlight segment of the target video based on the highlight segment analysis information.

In one implementation, the method further includes:

generating highlight segment prompt information of the target video according to the highlight segment; and pushing the highlight segment prompt information to a target client of the terminal, so that the target client prompts an object of the highlight segment of the target video.

In one implementation, generating highlight segment analysis information of the target video during the process of recording the target video includes:

during the process of recording the target video, performing highlight segment analysis processing on a sampled video frame of the target video from at least one analysis dimension to obtain an initial analysis result of the sampled video frame in different analysis dimensions; normalizing the initial analysis result to obtain target score information of the sampled video frame in different analysis dimensions; and determining highlight segment analysis information of the sampled video frame in the target video based on the target score information of the sampled video frame in different analysis dimensions.

In one implementation, generating or marking at least one highlight segment of the target video according to the highlight segment analysis information includes:

taking the sampled video frame with the highlight segment analysis information greater than a preset score threshold as a target video frame; determining an initial highlight segment based on the target video frame; performing segment processing on the initial highlight segment to obtain a processing result; and generating or marking at least one highlight segment of the target video based on the processing result.

In one implementation, performing segment processing on the initial highlight segment to obtain the highlight segment includes:

calculating a time interval between each initial highlight segment; and merging the initial highlight segments with the time interval less than a preset time threshold to obtain the highlight segment.

In one implementation, performing segment processing on the initial highlight segment to obtain the highlight segment includes:

determining a total duration of each initial highlight segment; determining a total duration threshold of the highlight segment based on the duration of the target video; and if the total duration is greater than the total duration threshold, performing segment processing on the initial highlight segment, so that the total duration is not greater than the total duration threshold.

In one implementation, if there are multiple initial highlight segments, the segment processing includes a discarding process. Performing segment processing on the initial highlight segment to make the total duration not greater than the total duration threshold includes:

determining a priority of each initial highlight segment; determining the initial highlight segment to be discarded according to the priority; and performing a discarding process on the initial highlight segment to be discarded.

In one implementation, if there is one initial highlight segment, the segment processing includes a cropping process. Performing segment processing on the initial highlight segment to make the total duration not greater than the total duration threshold includes:

determining a cropping quantity of the sampled video frame for the cropping process according to the total duration and the total duration threshold; and performing a cropping process on the sampled video frame at a start position of the initial highlight segment and the sampled video frame at an end position of the initial highlight segment according to the cropping quantity of the sampled video frame.

In a second aspect, the present disclosure further provides a camera device, including:

a camera, configured to record a target video;

at least one processor;

a display, the display is connected/coupled to the processor; and

a memory in communication with the processor, where the memory stores one or more computer programs including instructions; and when the instructions are executed by the processor, the processor is configured to:

during a process of recording a target video by the camera, generate or mark at least one highlight segment of the target video;

after the camera records the target video, in the case that a playback instruction for the target video is received, control the display to display a playback interface of the target video; and

receive and respond to an operation instruction for the highlight segment according to the playback interface.

In a third aspect, the present disclosure further provides an image processing device, the image processing device is in communication connection with a camera device, including:

one or more processors;

a display, the display is connected/coupled to the processor; and

a memory in communication with the processor, where the memory stores one or more computer programs including instructions; and when the instructions are executed by the processor, the processor is configured to:

obtain a target video recorded by the camera device, where the target video includes at least one highlight segment generated or marked during a process of recording the target video;

in the case that a playback instruction for the target video is received, control the display to display a playback interface of the target video; and

receive and respond to an operation instruction for the highlight segment according to the playback interface.

In a fourth aspect, the present disclosure further provides a video processing device, applicable to a camera device, the device includes:

a generation module, used to generate or mark at least one highlight segment of the target video during the process of recording the target video;

a display module, used to display a playback interface of the target video after the target video is recorded if a playback instruction for the target video is received; and

a response module, used to receive and respond to an operation instruction for the highlight segment according to the playback interface.

In a fifth aspect, the present disclosure further provides a computer device, including a memory and a processor. The memory stores a computer program, and the processor implements any of the video processing methods described in the first aspect when executing the computer program.

In a sixth aspect, the present disclosure further provides a computer-readable storage medium, on which a computer program is stored, and the computer program implements any of the video processing methods described in the first aspect when executed by a processor.

In a seventh aspect, the present disclosure further provides a computer program product, including a computer program, and the computer program implements any of the video processing methods described in the first aspect when executed by a processor.

The above video processing method, camera device, and image processing device are applicable to camera devices. First, during a process of recording a target video, at least one highlight segment of the target video is generated or marked. Then, after the target video is recorded, if a playback instruction for the target video is received, a playback interface of the target video is displayed, and an operation instruction for the highlight segment is received and responded to according to the playback interface. In this way, at least one highlight segment is obtained by processing the target video during the video recording period. After the target video is recorded, when the user triggers a playback instruction, the highlight segment can be displayed through the playback interface, and the user can operate the highlight segment on the playback interface to complete the video processing of the target video. In this way, the user does not need to manually edit the target video, making the operation more convenient. At the same time, the time-consuming process of processing the target video is synchronously completed during the video recording period by generating or marking, which saves video processing time and improves video processing efficiency.

### BRIEF DESCRIPTION OF DRAWINGS

In order to more clearly illustrate the technical solutions in the implementations or related technologies of the present disclosure, the drawings required for the description of the implementations or related technologies are briefly introduced below. It is obvious that the drawings described below are only some implementations of the present disclosure. For those of ordinary skill in the art, other drawings can also be obtained according to these drawings without creative work.

FIG. 1 is an application environment diagram of a video processing method, according to some implementations of the present disclosure.

FIG. 2 is a schematic diagram showing a first process flow of a video processing method, according to some implementations of the present disclosure.

FIG. 3 is a schematic diagram showing a second process flow of a video processing method, according to some implementations of the present disclosure.

FIG. 4 is a schematic diagram showing a first interface of a video processing method, according to some implementations of the present disclosure.

FIG. 5 is a schematic diagram showing a second interface of a video processing method, according to some implementations of the present disclosure.

FIG. 6 is a schematic diagram showing a third process flow of a video processing method, according to some implementations of the present disclosure.

FIG. 7 is a schematic diagram showing a third interface of a video processing method, according to some implementations of the present disclosure.

FIG. 8 is a schematic diagram showing a fourth process flow of a video processing method, according to some implementations of the present disclosure.

FIG. 9 is a schematic diagram showing a fourth interface of a video processing method, according to some implementations of the present disclosure.

FIG. 10 is a schematic diagram showing a fifth interface of a video processing method, according to some implementations of the present disclosure.

FIG. 11 is a schematic diagram showing a sixth interface of a video processing method, according to some implementations of the present disclosure.

FIG. 12 is a schematic diagram showing a seventh interface of a video processing method, according to some implementations of the present disclosure.

FIG. 13 is a schematic diagram showing an eighth interface of a video processing method, according to some implementations of the present disclosure.

FIG. 14 is a schematic diagram showing a fifth process flow of a video processing method, according to some implementations of the present disclosure.

FIG. 15 is a schematic diagram showing a sixth process flow of a video processing method, according to some implementations of the present disclosure.

FIG. 16 is a schematic diagram showing a seventh process flow of a video processing method, according to some implementations of the present disclosure.

FIG. 17 is a structural block diagram of a video processing device, according to some implementations of the present disclosure.

FIG. 18 is an internal structural diagram of a computer device, according to some implementations of the present disclosure.

The present disclosure will be described with reference to the accompanying drawings.

### DETAILED DESCRIPTION

In order to make the objectives, technical solutions, and advantages of the present disclosure clearer, the following provides a further detailed description of the present disclosure in conjunction with the accompanying drawings and implementations. It should be understood that the specific implementations described herein are only for explaining the present disclosure and are not intended to limit the present disclosure.

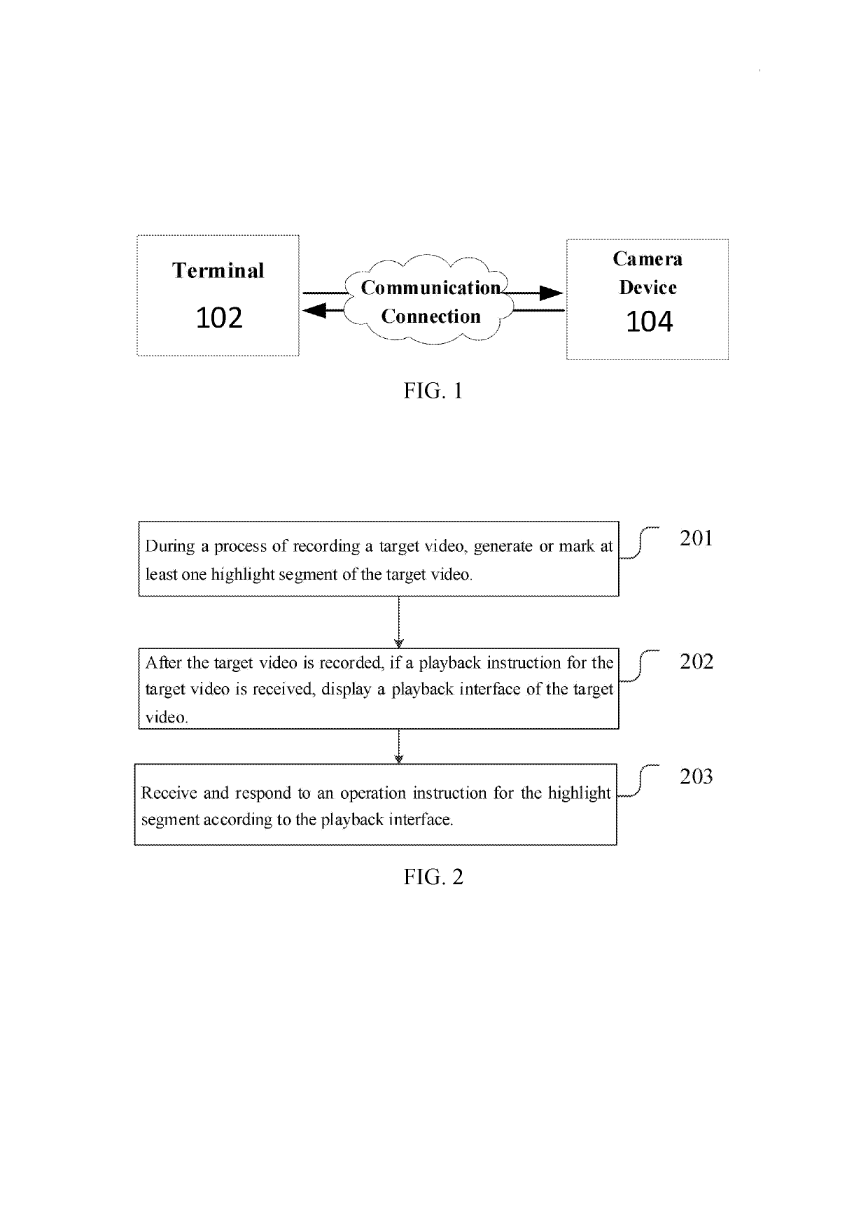

The video processing method provided in some implementations of the present disclosure can be applied in the application environment shown in FIG. 1. For example, terminal 102 can communicate with camera device 104 via a network, card reader, Universal Serial Bus (USB), or other means. Terminal 102 can include, but is not limited to, various personal computers, notebook computers, smartphones, tablet computers, Internet of Things (IoT) devices, and portable wearable devices. The IoT devices can be smart TVs, smart in-vehicle devices, etc. The portable wearable devices can be smart watches, etc. A target client program capable of controlling camera device 104 can be installed on terminal 102. Camera device 104 can include, but is not limited to, various devices capable of implementing shooting functions, such as cameras, camcorders, drones, and other devices that can be used to capture images.

Camera device 104 can include a display, for example, the display can include a touch screen. In some implementations, the size of the touch screen can be less than or equal to 3 inches. For example, the size of the touch screen can be less than or equal to 2.5 inches, such as 1.5 inches, 2.0 inches, 2.25 inches, 2.27 inches, 2.3 inches, and so on.

In one implementation, as shown in FIG. 2, a video processing method is provided. Taking the application of this method to camera device 104 in FIG. 1 as an example, the method includes the following operations 201 to 203.

Operation 201: during a process of recording a target video, generate or mark at least one highlight segment of the target video.

The target video is a video recorded by a user, and the highlight segment can be a high-quality segment in the target video. Through the highlight segment, the user can quickly understand the content of the target video, and can also generate a new video through the highlight segment, thereby achieving editing of the target video. In some implementations, the highlight segment can be automatically generated during the process of recording the target video, or can be manually marked by the user during the process of recording the target video.

For example, the highlight segment of the target video can include video segments in the target video that record moments such as smiling faces, cheers, waving arms, sports close-ups, objects of interest, high artistic sense, actions of interest, and other highlight moments. In other words, the highlight segment of the target video may include video segments that capture content considered to be of significant interest or importance. Such video segments may correspond to moments characterized by emotional expression, dynamic activity, prominent subjects, visually striking compositions, or other events likely to be perceived as meaningful or engaging by a user.

For example, during the process of recording the target video, the camera device can clip at least one highlight segment of the target video; or, during the process of recording the target video, the camera device can mark at least one highlight segment of the target video, so that after the target video is recorded, if a playback instruction for the target video is received (e.g., in response to receiving a playback instruction), a playback interface of the target video is displayed, and an operation instruction for the highlight segment is received and responded to according to the playback interface. The terms “according to the playback interface” and “based on the playback interface” can refer to actions that are carried out with elements shown on the playback screen, such as buttons, progress bars, or summary indicators. These elements are configured to allow a user to, e.g., view, select, edit, or export the highlight segment interactively through the playback interface.

In the present disclosure, the terms “if A is received” and “if B is detected” may be understood as being substantially equivalent to the conditional statements “in response to receiving A” and “in response to detecting B,” respectively. These phrases indicate that a particular action or process is initiated as a direct consequence of receiving a specific input of A or detecting a specific condition of B. The use of such interchangeable language is intended to cover variations in phrasing without altering the underlying logic or functionality described in the implementations of the present disclosure.

Operation 202: after the target video is recorded, if a playback instruction for the target video is received, display a playback interface of the target video.

The playback instruction for the target video can be the user entering the playback page, for example, by swiping left on the current interface to enter the playback page. After the target video is recorded, if a playback instruction for the target video is received, the highlight segment of the target video can be obtained, and further, at least one of the position of the highlight segment in the target video and the quantity of highlight segments can be determined. The playback interface can display information of the highlight segment of the target video. In some implementations, the quantity of highlight segments or the position of the highlight segment in the target video can be displayed.

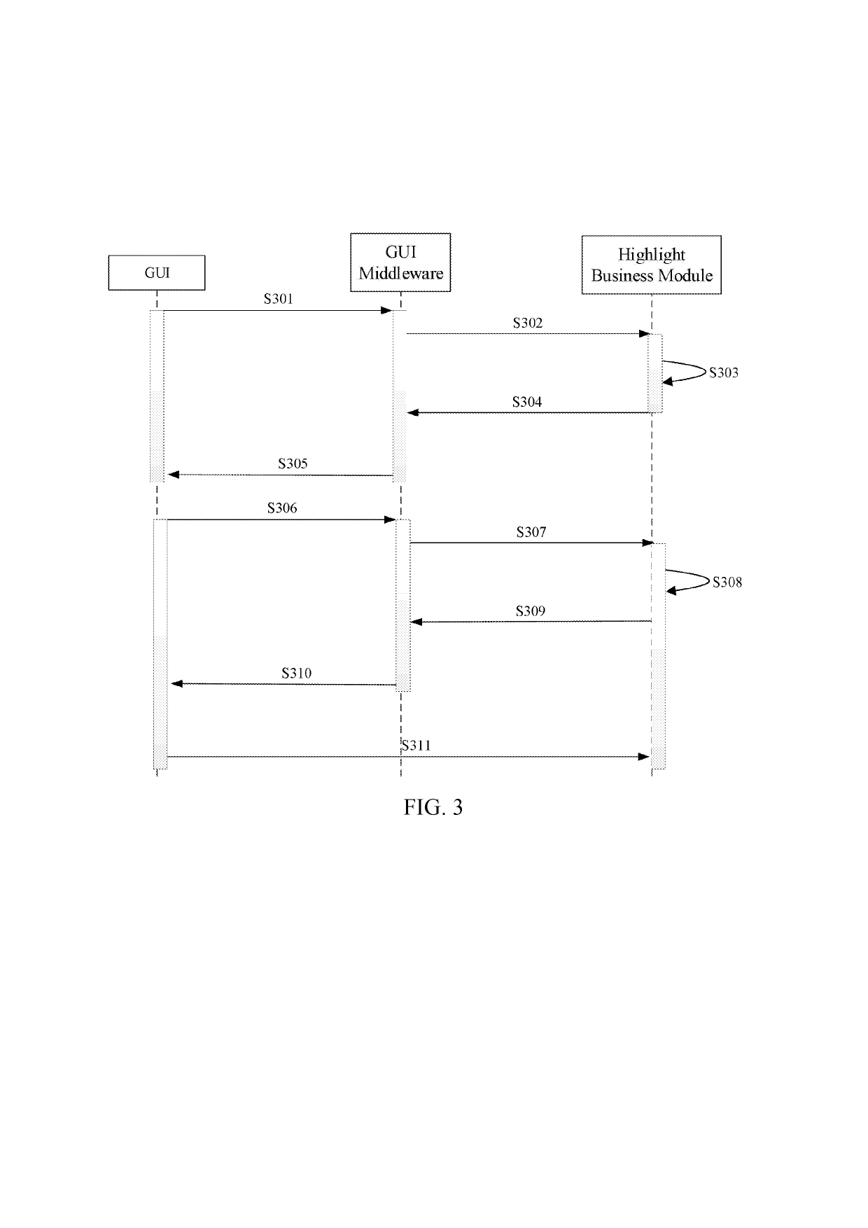

The process for obtaining the quantity and position of the highlight segment of the target video can be as shown in FIG. 3.

S301: the GUI (Graphical User Interface) sends a request to obtain highlight information to the GUI middleware.

The GUI middleware can be a software layer arranged between the graphical user interface (GUI) and the core logic of the application. It is configured to handle communication, event forwarding, and data translation to ensure smooth interaction between user actions and backend processing.

S302: the GUI middleware sends a request to obtain the quantity of highlight segments to the highlight business module.

S303: the highlight business module obtains highlight information.

S304: the highlight business module returns the quantity of highlight segments to the GUI middleware.

S305: the GUI middleware returns the quantity of highlight segments to the GUI.

S306: the GUI sends a request to obtain the position of the highlight segment to the GUI middleware.

S307: the GUI middleware sends a request to obtain the position of the highlight segment to the highlight business module.

S308: the highlight business module obtains highlight information.

S309: the highlight business module returns the position of the highlight segment to the GUI middleware.

S310: the GUI middleware returns the position of the highlight segment to the GUI.

S311: the GUI displays the highlight segment on the playback progress bar according to the position of the highlight segment.

Operation 203: receive and respond to an operation instruction for the highlight segment according to the playback interface.

In some implementations, the highlight segment can be operated on the playback interface, for example, clicking the highlight segment display control of the highlight segment can play the highlight segment in the target video, thereby achieving quick playback of the target video, and an export operation can also be performed on the highlight segment through an operation instruction.

It is worth noting that the form of the control in the present disclosure can be an icon, input box, button, etc. The present disclosure does not limit this, and will not elaborate further hereinafter.

In the above implementation, which is applicable to camera devices, first, during the process of recording the target video, at least one highlight segment of the target video is generated or marked. Then, after the target video is recorded, if a playback instruction for the target video is received, a playback interface of the target video is displayed, and an operation instruction for the highlight segment is received and responded to according to the playback interface. In this way, at least one highlight segment is obtained by processing the target video during the video recording period. After the target video is recorded, when the user triggers a playback instruction, the highlight segment can be displayed through the playback interface, and the user can operate the highlight segment on the playback interface to complete the video processing of the target video. In this way, the user does not need to manually edit the target video, making the operation more convenient. At the same time, the time-consuming process of processing the target video is synchronously completed during the video recording period by generating or marking, which saves video processing time and improves video processing efficiency.

In one implementation, the playback interface can include a highlight segment display control. Receiving and responding to an operation instruction for the highlight segment according to the playback interface can include: if a trigger operation for the highlight segment display control is detected (e.g., in response to detecting a trigger operation for the highlight segment display control), displaying a highlight segment playback interface, and playing the highlight segment in a loop according to the highlight segment playback interface.

It is worth noting that the form of the trigger operation in the present disclosure can be a specific touch operation, such as a single click, long press, double click, or swipe operation, etc., and can also be triggered by voice. In some implementations, the trigger operation can also be a combination of a series of operations. The present disclosure does not limit this.

In one implementation, the highlight segment display control can include quantity indication information, and the quantity indication information indicates a quantity of highlight segments in the target video.

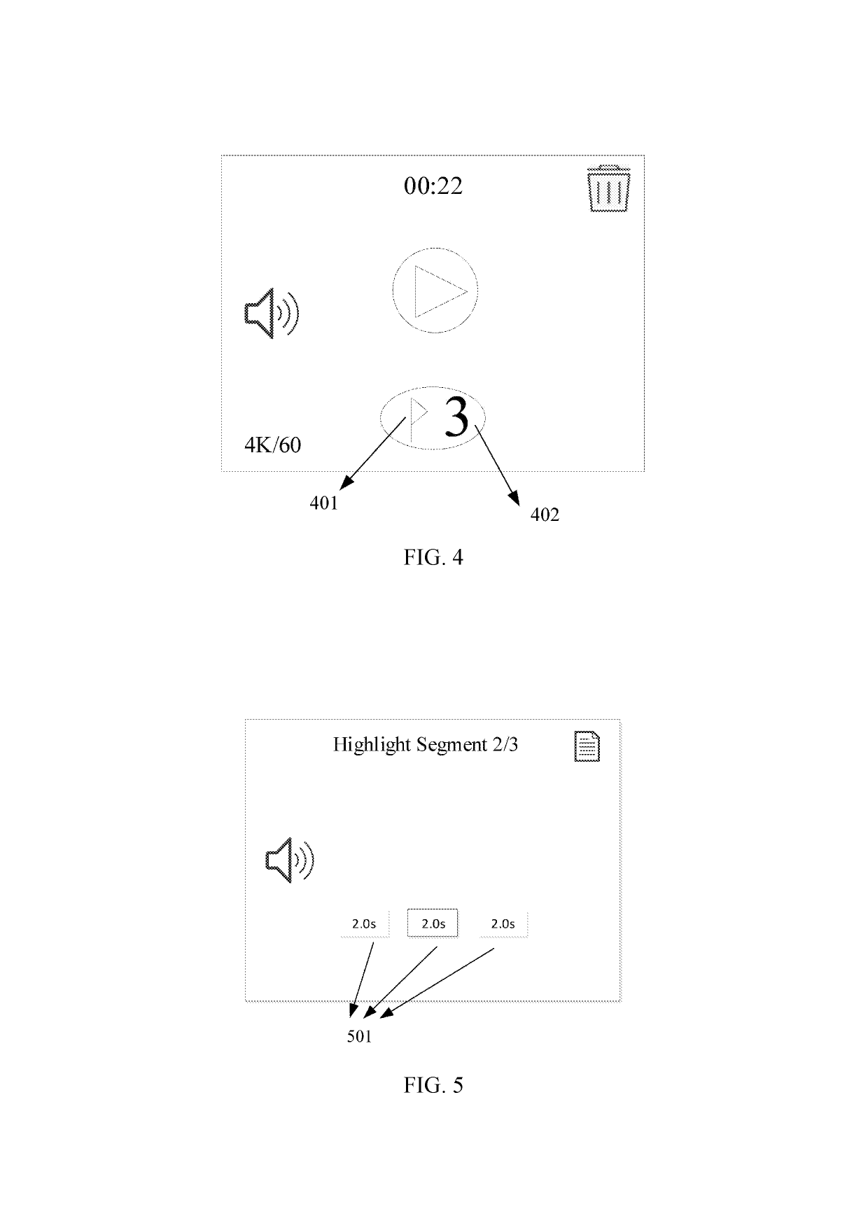

For example, the highlight segment display control is as shown by reference 401 in FIG. 4. If the user clicks the highlight segment display control, at this time, a trigger operation for the highlight segment display control is detected, and the highlight segment playback interface is entered to play the highlight segment in the target video. There can be one or more highlight segments in the target video. After one highlight segment is played, it can directly jump to the next segment and automatically circularly play. The quantity indication information is as shown by reference 402 in FIG. 4. For example, the quantity indication information is 3, that is, there are 3 highlight segments in the target video, and the 3 highlight segments can be played in a loop.

In the present disclosure, the terms “in a loop” and “circularly” may be used to refer to a repeated playback of content(s). These terms are used interchangeably in the description and are intended to convey the same concept with no distinction in meaning unless explicitly indicated.

In the above implementation, if a trigger operation for the highlight segment display control is detected, the highlight segment can be played in a loop, and the quantity of highlight segments can be displayed at the same time, which is convenient for the user to browse.

In one implementation, the highlight segment playback interface can further include a summary information list of the highlight segment. The summary information list can include at least one summary indication control of the highlight segment, and the summary indication control indicates summary information of the corresponding highlight segment. Circularly playing the highlight segment based on the highlight segment playback interface can include: during a process of playing the highlight segment in a loop based on the highlight segment playback interface, displaying the summary indication control corresponding to the currently played highlight segment based on a target display effect, and the target display effect is configured to distinguish the summary indication control of the currently played highlight segment from the summary indication controls of other highlight segments.

In order to facilitate the user's preview of the highlight segment, the highlight segment playback interface can further include a summary information list of the highlight segment. The summary information list can include summary indication controls corresponding one-to-one with the highlight segments. The summary indication control can display the summary information of the corresponding highlight segment. The summary information can be a simple summary of the highlight segment, for example, the summary information can be the duration of each highlight segment, the number of each highlight segment, a thumbnail of each highlight segment, a partial screenshot of the video frame in each highlight segment, user-customized content for each highlight segment, etc. During the process of circularly playing the highlight segment, the summary indication control corresponding to the currently played highlight segment is displayed based on the target display effect. The target display effect can distinguish the summary indication control of the currently played highlight segment from the summary indication controls of other highlight segments, which is convenient for the user to confirm which highlight segment is currently being played. In some implementations, the target display effect can be to highlight the summary indication control, frame the summary indication control, change the color of the summary indication control, change the size of the summary indication control, etc.

In some implementations, the highlight segment can also be switched through the summary indication control of the highlight segment. Triggering the summary indication control will play the highlight segment corresponding to the summary indication control. As shown in FIG. 5, reference 501 in the figure is one implementation of the summary indication control of the highlight segment. The three summary indication controls correspond to three highlight segments, and each summary indication control specifically displays the summary information of the duration of the corresponding highlight segment. As shown in FIG. 5, the currently played highlight segment is highlight segment 2, and the summary indication control corresponding to the second highlight segment is framed to prompt the user that the currently played highlight segment is highlight segment 2.

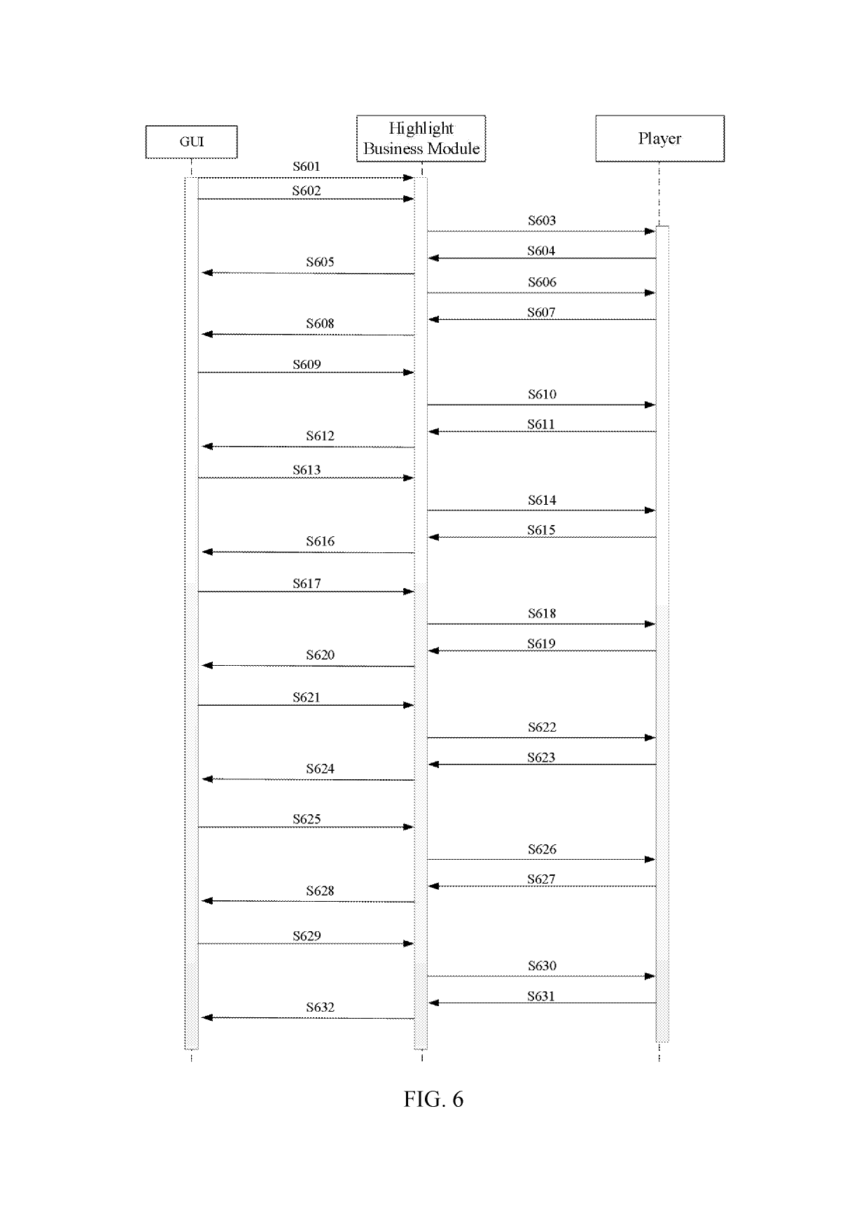

In some implementations, the playback process of the highlight segment can be as shown in FIG. 6.

S601: enter the player.

S602: the user sends a playback instruction through the GUI.

For example, trigger the highlight segment display control.

S603: the highlight business module sends an instruction to find the first highlight segment to the player.

S604: the player plays the first highlight segment, and after playback is completed, playback completion is returned to the highlight business module.

S605: the highlight business module sends an instruction to the GUI to update the playback status, and then automatically switch to the next highlight segment.

S606: the highlight business module sends an instruction to find the second highlight segment to the player.

S607: the player plays the second highlight segment, and after playback is completed, playback completion is returned to the highlight business module.

S608: the highlight business module sends an instruction to the GUI to update the index of the played highlight segment.

S609: the user triggers a playback pause operation in the GUI.

S610: the highlight business module forwards the pause operation to the player.

S611: the player stops playing and returns pause completion to the highlight business module.

S612: the highlight business module returns to the GUI to update the playback status.

S613: the user triggers a playback start operation in the GUI.

S614: the highlight business module forwards restart to the player.

S615: the player restarts playback and returns restart success to the highlight business module.

S616: the highlight business module sends an instruction to the GUI to update the playback status.

There are various ways to switch highlight segments, for example, one way is to switch highlight segments during playback, and another way is to switch highlight segments after pausing. The process for switching highlight segments during playback is as shown in operations S617 to S620.

S617: the user sends a switch highlight segment instruction to the highlight business module through the GUI.

In some implementations, switching can be performed through the summary indication control of the highlight segment.

S618: the highlight business module issues an instruction to find the n^{th} highlight segment after switching to the player.

S619: the player plays the n^{th} highlight segment, and after playback is completed, playback completion is returned to the highlight business module.

S620: the highlight business module sends an instruction to the GUI to update the index of the played highlight segment.

The process for switching segments after pausing is as shown in operations S621 to S632.

S621: the user triggers a playback pause operation in the GUI.

S622: the highlight business module forwards the pause operation to the player.

S623: the player stops playing and returns pause completion to the highlight business module.

S624: the highlight business module returns to the GUI to update the playback status.

S625: the user sends a switch segment instruction to the highlight business module in the GUI.

S626: the highlight business module issues an instruction to jump to the n^{th} highlight segment after switching to the player.

S627: the player finds the n^{th} highlight segment and then returns jump completion to the highlight business module.

S628: the highlight business module returns to the GUI to update the index of the played highlight segment.

S629: if the user triggers a playback start operation in the GUI.

S630: the highlight business module sends an instruction to find the n^{th} highlight segment to the player.

S631: the player plays the n^{th} highlight segment, and after playback is completed, playback completion is returned to the highlight business module.

S632: the highlight business module returns to the GUI to update the playback status.

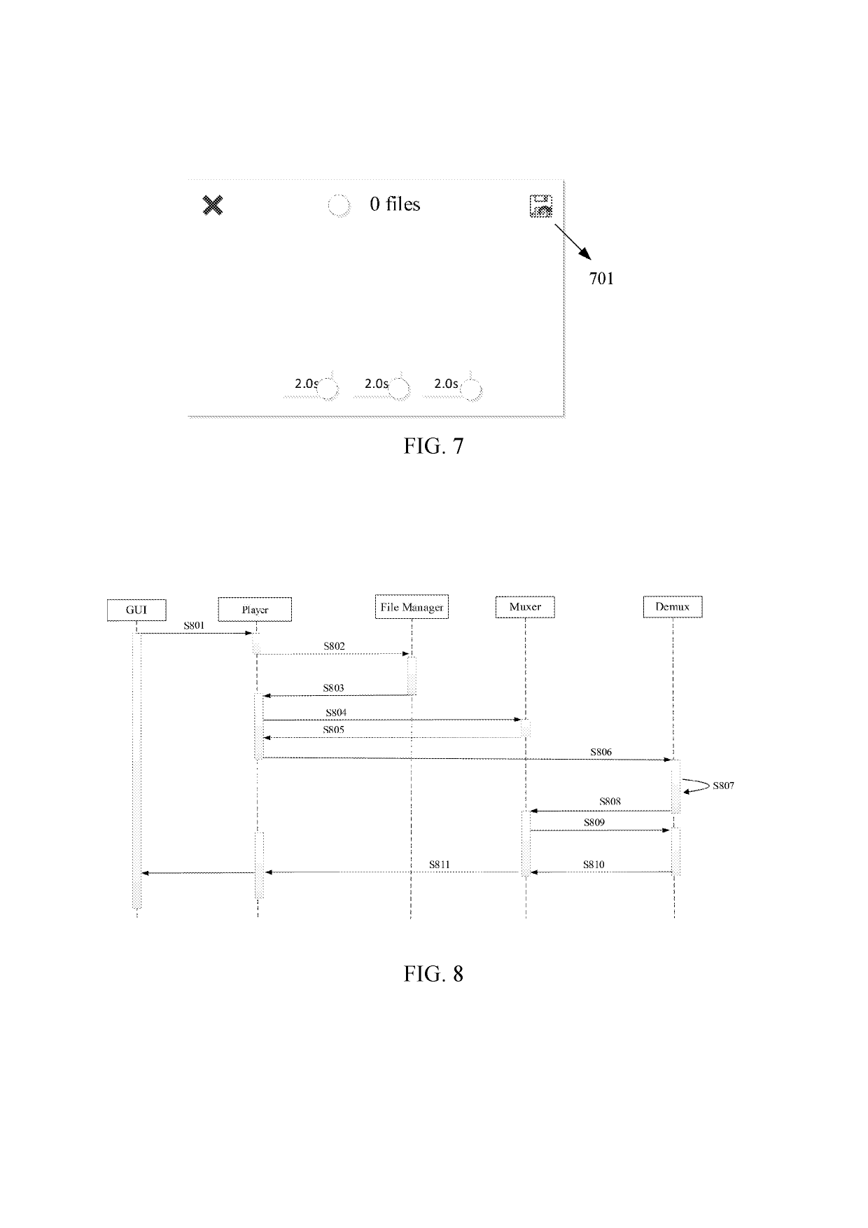

In one implementation, in order to achieve automatic editing of the target video, the generated highlight segment can be automatically exported. The highlight segment playback interface can further include a highlight segment export control. The method can further include: if a trigger operation for the highlight segment export control is detected (e.g., in response to detecting a trigger operation for the highlight segment export control), performing an export process on the highlight segment corresponding to the selected summary indication control. The user can export the highlight segment by triggering the highlight segment export control. The highlight segment export control can be as shown by reference 701 in FIG. 7.

For example, the highlight segment playback interface can further include a highlight segment selection control. During the process of circularly playing the highlight segment based on the highlight segment playback interface, if a trigger operation for the highlight segment selection control is detected, a selection box can be displayed on the summary indication control corresponding to each highlight segment. The highlight segment corresponding to the summary indication control can be selected by triggering the selection box. After the selection is completed, the highlight segment corresponding to the selected summary indication control can be exported by triggering the highlight segment export control.

In some implementations, considering that the target video can include at least one highlight segment, there can be multiple highlight segment export methods. That is, after the selection is completed, the highlight segment corresponding to the selected summary indication control can be exported by triggering the highlight segment export control. Specifically, it can include:

if a trigger operation for the highlight segment export control is detected, display an export interface, where the export interface includes at least one export type control; and

according to the export type corresponding to the selected export type control, perform an export process on the highlight segment corresponding to the selected summary indication control.

There can be various ways to export the highlight segment. For example, multiple highlight segments can be exported separately to obtain video files corresponding to each highlight segment. The export type corresponding to this highlight segment export method can be a segmented export type.

In some implementations, multiple highlight segments can be merged to obtain at least one merged highlight segment, and then each merged highlight segment can be exported separately to obtain video files corresponding to each merged highlight segment. The export type corresponding to this highlight segment export method can be a merged export type.

It is worth noting that in practical applications, there can be various ways to merge multiple highlight segments. As an example, multiple highlight segments can be merged into one merged highlight segment. As another example, multiple highlight segments can be merged into multiple merged highlight segments according to different strategies. For example, highlight segments with similar highlight segment analysis information scores can be merged; or highlight segments with the same object of interest can be merged; or highlight segments with similar image parameters such as brightness and color distribution can be merged; and so on.

In some implementations, the export types can include a segmented export type and a merged export type. According to the export type corresponding to the selected export type control, perform an export process on the highlight segment corresponding to the selected summary indication control. This can include:

if the export type corresponding to the selected export type control is the segmented export type, perform an export process on the highlight segment corresponding to the selected summary indication control respectively. That is, export the highlight segment corresponding to the selected summary indication control as independent video files.

If the export type corresponding to the selected export type control is the merged export type, merge the highlight segments corresponding to the selected summary indication control and then export. That is, merge the highlight segments corresponding to the selected summary indication control into at least one, and then export at least one video file. For instance, the merging may follow chronological order or group segments by similarity in contents or score values.

It is worth noting that there can be various ways to perform the export process on the relevant highlight segment. For example, the camera can clip the relevant highlight segment from the target video, or the camera can clip the relevant highlight segment from the target video through the terminal device.

For example, the export process of the highlight segment is as shown in FIG. 8.

S801: The user selects the export file through the GUI and sends it to the player.

S802: The player sends a request to the file manager to check the disk space.

S803: The file manager returns the created file name.

S804: The player invokes the packaging module “Muxer” to create a new Muxer instance.

S805: Muxer returns a handle.

The term “handle” is used to indicate a reference or identifier used by a program during runtime to access and manage a specific resource, such as a file. It is a value (often a number or pointer) assigned by the system that allows indirect access to the resource. Handles enable the program to perform operations like reading, writing, or closing the resource without needing to manage its internal structure directly.

S806: The player sends a demuxing request to the demux module “Demux.”

S807: Demux determines and identifies the highlight interval.

S808: The media data is written to the Muxer.

S809: Once writing is complete, the Muxer requests the next frame from Demux.

S810: This continues until all highlight data is written.

S811: The Muxer returns a completion status notification to the player.

S812: The player notifies the user interface (UI) that the export is complete.

In the above implementation, by exporting the highlight segment after selection, the user can easily complete the editing of the target video, reducing the complexity of video processing.

In one implementation, the playback interface can further include a video play control. The method can further include:

if a trigger operation for the video play control is detected (e.g., in response to detecting a trigger operation for the video play control), play the target video, and during a process of playing the target video, display a playing position interval corresponding to the highlight segment in the target video on a first progress bar of the target video.

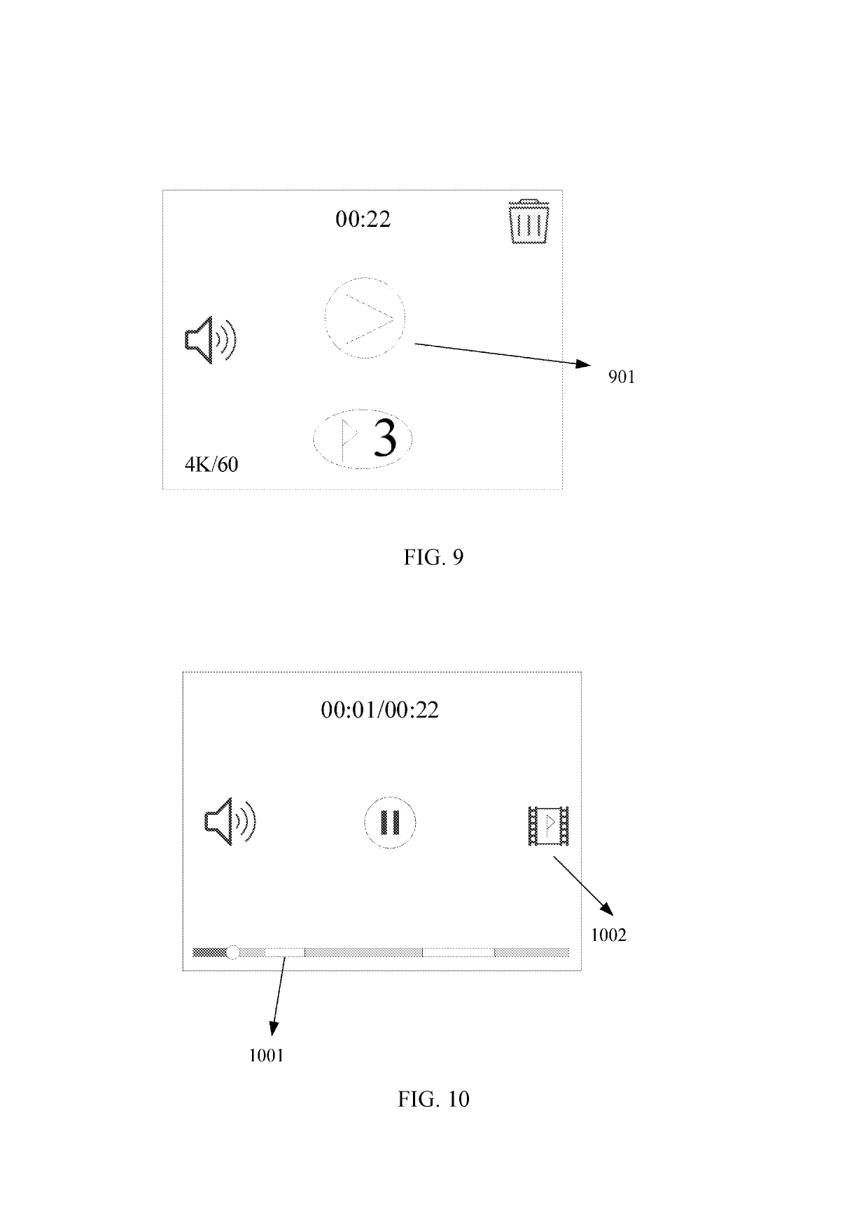

The video play control can be used to trigger the playback of the target video. The playback page can display both the video play control and the highlight segment play control at the same time, so that the user can choose to view the target video or the highlight segment. For example, the video play control can be as shown by reference 901 in FIG. 9. During the process of playing the target video, a first progress bar of the target video is displayed. The first progress bar can display the playing position interval corresponding to each highlight segment and each non-highlight segment included in the target video. In this way, during the process of playing the target video, the play progress indication control on the first progress bar can move to different positions on the first progress bar as the video playback progresses, indicating the current playback progress of the target video.

In some implementations, the playing position interval corresponding to the highlight segment can be distinguished and displayed on the first progress bar by highlighting, changing the display color, adjusting the display transparency, or adjusting the display size, etc. For example, the first progress bar can be as shown by reference 1001 in FIG. 10, where there are two highlight segments in the first progress bar 1001, such as the white parts in the first progress bar 1001.

In some implementations, the playback interface can further include a highlight segment editing control. During the process of playing the target video, the highlight segment can be edited. The operations can include:

if a trigger operation for the highlight segment editing control is detected during a process of playing the target video, displaying a current playing progress of the target video in real time on a second progress bar of the target video. For example, the highlight segment editing control can be as shown by reference 1002 in FIG. 10.

The second progress bar is configured to display the playing position interval corresponding to the highlight segment in the target video. Specifically, the second progress bar can be used to display the playing position interval corresponding to a local video segment in the target video. The local video segment includes the currently played video segment and part of the video segments adjacent to the currently played video segment. In this way, as the target video is played, the playing position interval displayed on the second progress bar will also change in real time.

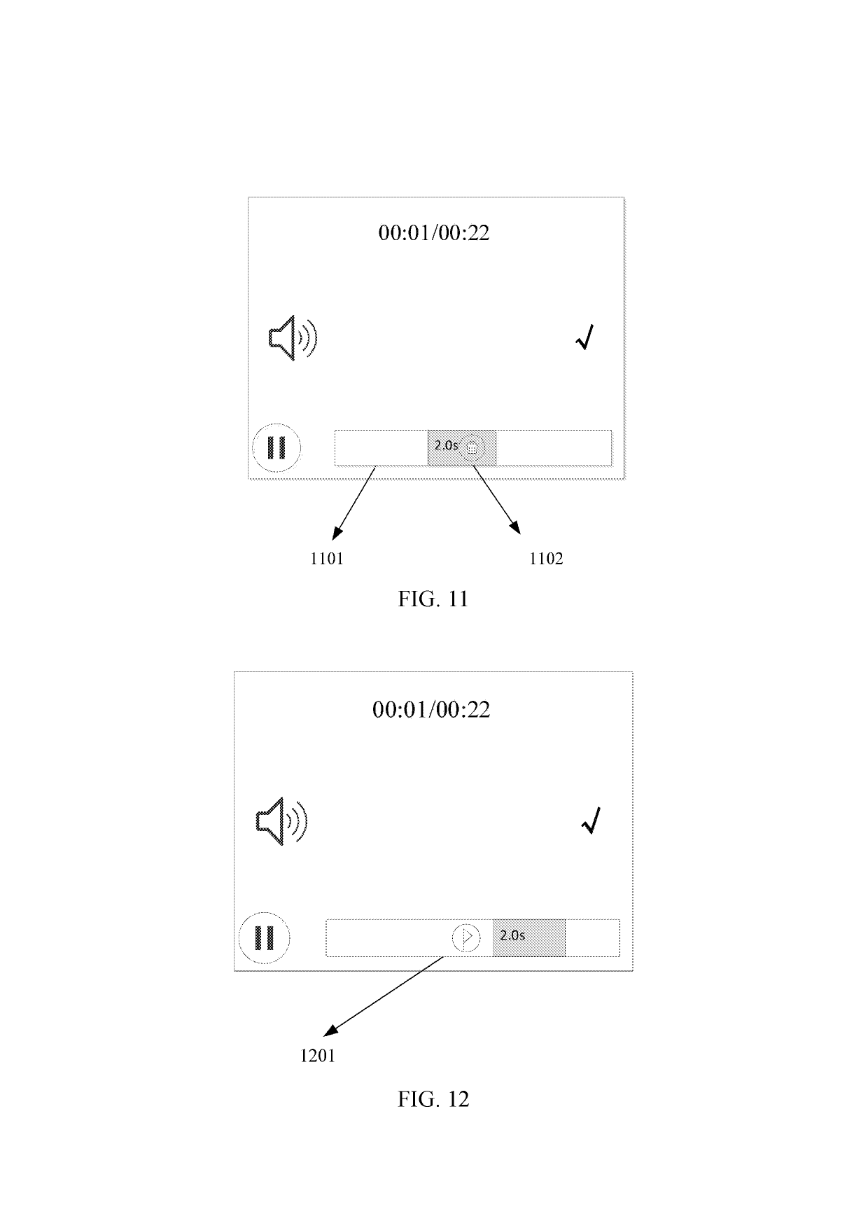

The size of the second progress bar can be set to be greater than the size of the first progress bar, so that the user can more conveniently edit the currently played video segment in the target video on the camera device. For example, the width of the second progress bar can be greater than the width of the first progress bar, which makes it more convenient for the user to perform editing operations on the video segment of the target video on the camera device. For example, the second progress bar can be as shown by reference 1101 in FIG. 11.

In some implementations, a preset position of the second progress bar can be provided with a play progress indication control. The play progress indication control indicates the current play progress of the target video. The method can further include:

if the play progress indication control indicates that the current playing video segment interval is the playing position interval corresponding to the highlight segment, and a highlight segment deletion operation for the play progress indication control is detected, modifying the currently played highlight segment as a non-highlight segment.

For example, the preset position can be a fixed position. For example, the play progress indication control can be set in the middle of the second progress bar, and as the target video is played, the playing position interval corresponding to different local video segments in the target video can be displayed in real time on the second progress bar. Since the play progress indication control is fixedly displayed in the middle of the second progress bar, during the process of playing the target video, if the playing position interval of the video segment overlaps with the position of the play progress indication control, the video segment indicated by the play progress indication control can be determined as the currently played video segment in the target video.

In some implementations, the preset position can be a position specified by the user. For example, the user can set the position of the play progress indication control on the second progress bar by dragging, double-clicking, single-clicking, long-pressing, etc., so that the user can still conveniently edit the highlight segment in the target video through the play progress indication control when holding the camera device with one hand.

The target video can include multiple highlight segments and multiple non-highlight segments. For example, the video segments in the target video other than the highlight segment can be determined as non-highlight segments. The play progress indication control indicates whether the current playing video interval is a highlight segment or a non-highlight segment. When the current playing position interval is a highlight segment, the play progress indication control can be displayed in a first state as shown by reference 1102 in FIG. 11. If a highlight segment deletion operation for the play progress indication control is detected (e.g., in response to detecting a highlight segment deletion operation for the play progress indication control), for example, if a trigger operation for the play progress indication control in the first state is detected, the currently played video segment can be modified from a highlight segment to a non-highlight segment.

If the play progress indication control indicates that the current playing video segment interval is not the playing position interval corresponding to the highlight segment, and a highlight segment generation operation for the play progress indication control is detected, a highlight segment is generated based on the current playing position interval of the second progress bar.

As an example, if the currently played interval is the playing position interval corresponding to a non-highlight segment, the play progress indication control can be displayed in a second state as shown by 1201 in FIG. 12. If a highlight segment generation operation for the play progress indication control is detected, for example, if a trigger operation for the play progress indication control in the second state is detected, a highlight segment can be generated based on the currently played non-highlight segment. In some implementations, in order to prevent the highlight segment from being excessively fragmented, generating a highlight segment based on the current playing position interval of the second progress bar can include the following.

First case: if there is no highlight segment in the preset interval threshold of the current playing position interval of the second progress bar, generating an independent highlight segment based on the current playing position interval.

If there is no other highlight segment in the preset interval threshold of the current playing position interval of the play progress indication control triggered by the user, an independent highlight segment can be generated in the current playing position interval. In some implementations, a highlight segment of a preset duration can be generated, or a highlight segment can be generated according to the user's operation on the play progress indication control. For example, the time from when the user long-presses the play progress indication control to when the user releases the play progress indication control can be used as the time of the generated highlight segment.

Second case: if there is a highlight segment in the preset interval threshold of the current playing position interval of the second progress bar, generating a merged highlight segment based on the current playing position interval and the highlight segment in the preset interval threshold, and the merged highlight segment includes the highlight segment in the preset interval threshold.

If there is a highlight segment in the preset interval threshold of the current playing position interval, the current playing position interval and the highlight segment in the preset interval threshold can be merged into one highlight segment, and the information of the modified highlight segment can be saved to the target video.

In the above implementation, the first progress bar is displayed during the process of playing the target video. When the highlight segment editing control is triggered, the second progress bar is displayed. The play progress indication control of the second progress bar can be used to edit the highlight segment, making it more flexible. At the same time, during the editing process, by judging the highlight segment in the preset interval threshold, it is possible to avoid generating excessively fragmented highlight segments.

In one implementation, generating or marking at least one highlight segment of the target video during the process of recording the target video can include:

during the process of recording the target video, if a highlight segment marking operation for the target video is detected, generating or marking at least one highlight segment of the target video based on a video recording screen corresponding to the highlight segment marking operation.

The form of the highlight segment marking operation can be a specific touch operation, such as a single click, long press, double click, or swipe operation, etc., and can also be triggered by voice. In some implementations, the highlight segment marking operation can also be a combination of a series of operations.

For example, detecting a highlight segment marking operation for the target video can be detecting that the user marks the highlight segment through a trigger control or other operation, that is, the user can customize the highlight segment in the target video. After detecting a highlight segment marking operation for the target video, a highlight segment can be obtained based on the video recording screen corresponding to the highlight segment marking operation.

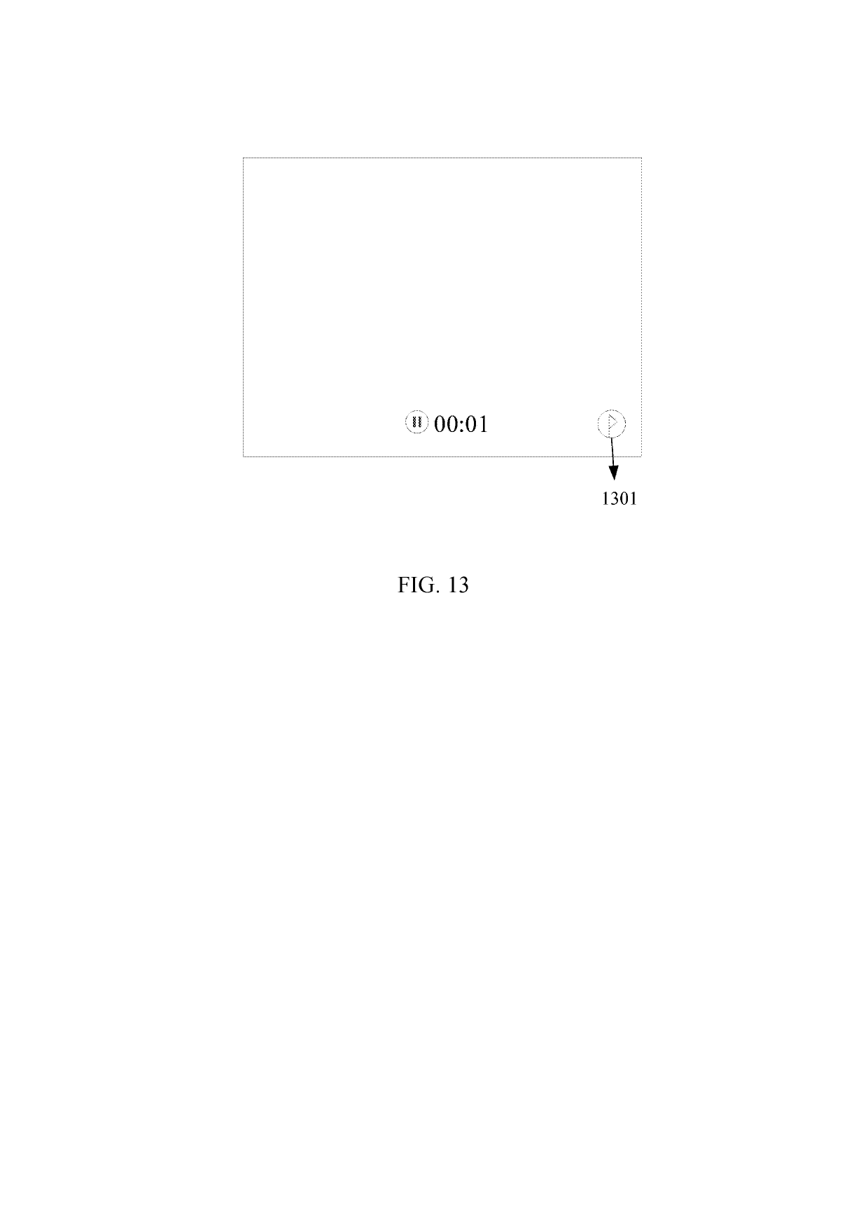

In some implementations, the video recording interface of the target video can include a highlight segment marking control. For example, the highlight segment marking control can be as shown by reference 1301 in FIG. 13. Then, if a highlight segment marking operation for the target video is detected, generating or marking at least one highlight segment of the target video based on a video recording screen corresponding to the highlight segment marking operation can include:

if a trigger operation for the highlight segment marking control is detected (e.g., in response to detecting a trigger operation for the highlight segment marking control), generating or marking at least one highlight segment of the target video based on a video recording screen corresponding to the trigger operation.

In some implementations, the way of generating or marking at least one highlight segment of the target video after detecting a trigger operation for the highlight segment marking control can include generating a highlight segment of a preset duration after detecting one operation for the highlight segment marking control, or generating a highlight segment based on the video recording screen corresponding to the time interval between two operations after detecting two operations for the highlight segment marking control.

In the above implementation, during the process of recording the target video, the user can mark the target video through the highlight segment marking control, and at least one highlight segment of the target video can be generated or marked, thereby facilitating subsequent video editing based on the highlight segment, and making the generation of the highlight segment more convenient.

In one implementation, generating or marking at least one highlight segment of the target video during the process of recording the target video can include:

during the process of recording the target video, generating highlight segment analysis information of the target video; and generating or marking at least one highlight segment of the target video according to the highlight segment analysis information.

The highlight segment analysis information is generated based on highlight segment analysis processing performed on the target video during the video recording period. In some implementations, during the process of recording the target video, the highlight segment analysis information of the target video can be determined through a preset algorithm. For instance, the highlight segment analysis information can be based on object detection, facial expression recognition, and motion scoring algorithms. Then, according to the highlight segment analysis information, at least one highlight segment of the target video can be generated or marked. In this way, during the process of recording the target video, the camera device can generate or mark at least one highlight segment of the target video.

In one implementation, after the highlight segment analysis information of the target video is generated by performing highlight segment analysis processing on the target video during the video recording period, the camera device can further send the highlight segment analysis information to the terminal, so that the terminal can also generate at least one highlight segment of the target video according to the highlight segment analysis information. Specifically, the method can further include the following.

Sending the highlight segment analysis information to a terminal, so that the terminal generates the highlight segment of the target video based on the highlight segment analysis information. The camera sends the highlight segment analysis information generated during the video recording period to the terminal. The terminal is installed with a target client, and the terminal can generate the highlight segment of the target video according to the received highlight segment analysis information through the target client. For example, the terminal can clip the highlight segment from the target video according to the received highlight segment analysis information through the target client.

In some implementations, after the camera automatically generates the highlight segment, the user can also be prompted to view it, including:

generating highlight segment prompt information of the target video according to the highlight segment; and pushing the highlight segment prompt information to a target client of the terminal, so that the target client prompts an object of the highlight segment of the target video.

The highlight segment prompt information can be a message notification, etc. After the camera generates or marks the highlight segment, the highlight segment prompt information corresponding to the target video can be generated, and then the highlight segment prompt information can be sent to the target client of the terminal, so that the user can view the highlight segment of the target video through the target client. After receiving the highlight segment prompt information, the user can choose to view the highlight segment of the target video according to the highlight segment prompt information, or not to view it.

In the above implementation, the camera can generate or mark the highlight segment according to the target video, or communicate with the terminal, and the highlight segment can be generated by the terminal. At the same time, after the highlight segment is generated, highlight segment prompt information can also be generated and sent to the target client of the terminal to remind the user to view it, making it more flexible to use.

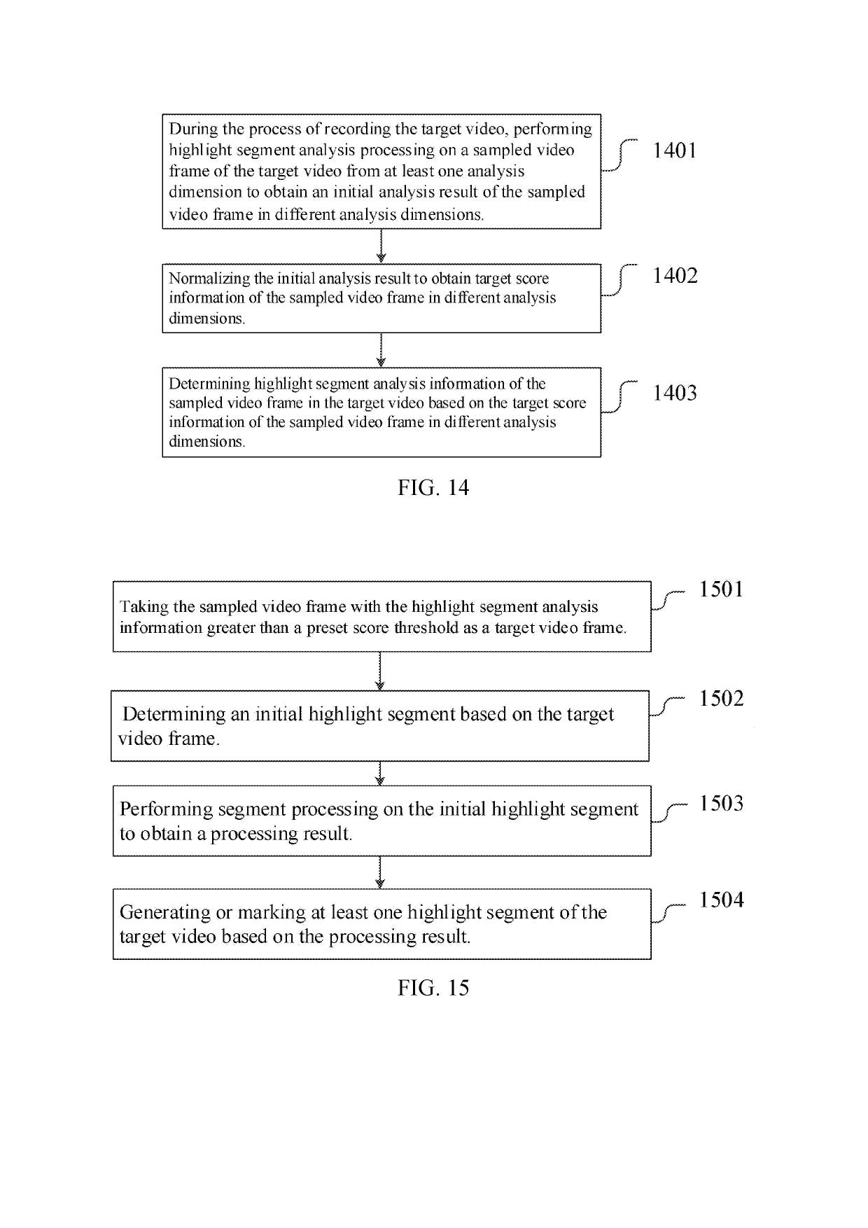

In the implementations of the present disclosure, in order to achieve automatic editing of the target video through the highlight segment, it is also necessary to first determine the highlight segment in the target video, that is, to perform highlight segment analysis processing on the target video. As shown in FIG. 14, during the process of recording the target video, generating highlight segment analysis information of the target video can include:

operation 1401: during the process of recording the target video, performing highlight segment analysis processing on a sampled video frame of the target video from at least one analysis dimension to obtain an initial analysis result of the sampled video frame in different analysis dimensions.

In the implementation, video analysis is performed by analyzing sampled video frames, such as extracting 5 frames per second for analysis. The analysis dimension can be to perform highlight segment analysis processing on the sampled video frame of the target video through different analysis algorithms, which can include at least one of an object detection algorithm, an action recognition algorithm, or an aesthetic evaluation algorithm. The initial analysis result is the analysis result obtained according to different analysis dimensions. In some implementations, the object detection algorithm can detect objects in the sampled video frame, the action recognition algorithm can recognize actions in the sampled video frame, such as waving arms, various sports actions, etc., and the aesthetic evaluation algorithm can score the aesthetic result of the sampled video frame by extracting image features in the sampled video frame. In some implementations, an expression recognition algorithm can also be included to recognize expressions in the sampled video frame, such as smiling faces, crying expressions, etc. A sound recognition algorithm can also be included to detect sounds in the target video, such as detecting cheers, laughter, singing, etc., determining the sampled video frame where the sound appears.

Operation 1402: normalizing the initial analysis result to obtain target score information of the sampled video frame in different analysis dimensions.

The initial analysis results of different analysis dimensions are normalized respectively to obtain the target score information of the sampled video frame corresponding to different analysis dimensions. For example, the object detection algorithm can detect objects in the sampled video frame, and a higher score can be given to objects of interest such as artistic sculptures, for example, 10 points, and a lower score can be given to ordinary objects such as chairs, for example, 1 point. The term “normalization” may refer to the process of converting the initial analysis results from different dimensions into a unified score scale to enable consistent evaluation. That is, the initial analysis result is normalized and converted into a unified score, and the same normalization processing is performed for different analysis dimensions to obtain the target score information of the sampled video frame corresponding to different analysis dimensions. For example, the object detection algorithm performs sampling video frame recognition at 3 frames per second on a 2-second video, and the target score information of the object detection algorithm may be in the format of [0, 1, 0, 2, 4, 9].

The array [0, 1, 0, 2, 4, 9] in the example represents the target score information assigned by the object detection algorithm to six video frames that were sampled from a 2-second video at a rate of 3 frames per second. Each number in the array can correspond to one sampled frame and reflect the significance or relevance of the detected content in that frame. A score of 0 means the algorithm detects no meaningful object or event in that frame, while a higher value (such as 4 or 9) can indicate a stronger presence of interesting or important content. For instance, the final frame with a score of 9 likely contains a highly relevant object or action, making it a strong candidate for being part of the highlight segment. This scoring system can help identify and extract the most valuable parts of the video for further processing or playback.

Operation 1403: determining highlight segment analysis information of the sampled video frame in the target video based on the target score information of the sampled video frame in different analysis dimensions.

For each sampled video frame, the initial scores corresponding to different types of highlight segment analysis algorithms are statistically processed to obtain the analysis score of the sampled video frame.

The target score information of the sampled video frame in different analysis dimensions is statistically processed to determine the highlight segment analysis information of the sampled video frame in the target video. The statistical processing can be to weigh the initial scores obtained by different types of highlight segment analysis algorithms according to the importance of the highlight segment analysis algorithm. The higher the importance, the higher the weight. After weighting, the analysis score of the sampled video frame is obtained, and then the analysis score is used as the highlight segment analysis information.

In some implementations, the highlight segment analysis information can be saved in the target video or other configuration files, so that when the target video needs to be played back, analysis can be performed according to the highlight segment analysis information. In some implementations, it can be determined whether highlight segment analysis processing needs to be performed on the target video during the process of recording the target video through an analysis assistant control. If highlight segment analysis processing needs to be performed during the process of recording the target video, the analysis assistant control can be turned on before recording the video. If highlight segment analysis processing does not need to be performed during the process of recording the video, the analysis assistant control can be turned off.

In one implementation, the operation of displaying the playback interface of the target video according to the highlight segment analysis information is as shown in FIG. 15, including the following.

Operation 1501: taking the sampled video frame with the highlight segment analysis information greater than a preset score threshold as a target video frame.

The preset score threshold can be set by the user. The sampled video frame with a highlight segment analysis score greater than the preset score threshold is determined as the target video frame.

Operation 1502: determining an initial highlight segment based on the target video frame.

The determined multiple target video frames are combined to form the initial highlight segment. For example, if the preset score threshold is set to 3, all sampled video frames with an analysis score greater than 3 will be selected as target video frames. When the highlight segment analysis information is [(1, 1), (2, 3), (3, 5), (4, 3), (5, 2), (6, 3)], where the first number is the number/index of the sampled video frame and the second number is the analysis score, the target video frames can be determined as [(2, 3), (3, 5), (4, 3)] and [(6, 3)] (with the second number being greater than the preset score threshold of 3). According to the target video frames, two initial highlight segments can be determined.

Operation 1503: performing segment processing on the initial highlight segment to obtain a processing result.

Operation 1504: generating or marking at least one highlight segment of the target video based on the processing result.

If the initial highlight segment is too fragmented or the total duration is too long, segment processing of the initial highlight segment is also required. The segment processing includes two cases as follows.

First case: calculating a time interval between each initial highlight segment; and merging the initial highlight segments with the time interval less than a preset time threshold to obtain the highlight segment.

In order to improve the continuity of the highlight segment, adjacent initial highlight segments can be merged. The time interval between each initial highlight segment is calculated. If the time interval is less than a preset time threshold, that is, the two initial highlight segments are very close, they can be merged to ensure the coherence of the highlight segment. The preset time threshold can be set by the user. For example, if the preset time threshold is set to 0.5 seconds, all initial highlight segments with a time interval less than 0.5 seconds will be merged into one highlight segment.

Second case: determining a total duration of each initial highlight segment; determining a total duration threshold of the highlight segment based on the duration of the target video; and if the total duration is greater than the total duration threshold, performing segment processing on the initial highlight segment, so that the total duration is not greater than the total duration threshold.

If the duration of the highlight segment is too long and the difference from the duration of the target video is not large, the function of the highlight segment is not achieved, so segment processing is required. The total duration threshold is determined based on the duration of the target video. In some implementations, it can be calculated by the duration of the target video and a ratio. The total duration of each initial highlight segment cannot exceed the total duration threshold. If the total duration exceeds the total duration threshold, that is, the total duration of each initial highlight segment is too long, and the goal of helping the user improve the efficiency of editing and playback of the target video cannot be achieved, segment processing can be performed on the initial highlight segment to make the total duration meet the requirements.

In some implementations, the segment processing can include a discarding process or a cropping process. If there are multiple initial highlight segments, the segment processing includes a discarding process. Performing segment processing on the initial highlight segment to make the total duration not greater than the total duration threshold includes: determining a priority of each initial highlight segment; determining the initial highlight segment to be discarded according to the priority; and performing a discarding process on the initial highlight segment to be discarded.

When there are multiple initial highlight segments, the average score of each initial highlight segment is calculated, and the priority of each initial highlight segment is determined according to the average score. The higher the average score, the higher the priority; the lower the average score, the lower the priority. In some implementations, the initial highlight segment with lower priority is determined as the initial highlight segment to be discarded, and then the initial highlight segment to be discarded is discarded until the total duration of each initial highlight segment does not exceed the total duration threshold. For example, when the preset duration is 3 sampled video frames, there are 2 initial highlight segments, [(1, 3), (2, 3)] and [(4, 3), (5, 4)], and the total length is 4 sampled video frames, which exceeds the length limit of 3, so one initial highlight segment needs to be discarded. The average score of the first initial highlight segment is (3 + 3) / 2 = 3, and the average score of the second initial highlight segment is (3 + 4) / 2 = 3.5. The average score of the first initial highlight segment is lower, that is, the priority of the first initial highlight segment is lower. Therefore, the first initial highlight segment is discarded, and the second initial highlight segment is retained, which can meet the duration limit.

In some implementations, if there is one initial highlight segment, the segment processing includes a cropping process. Performing segment processing on the initial highlight segment to make the total duration not greater than the total duration threshold includes: determining a cropping quantity of the sampled video frame for the cropping process according to the total duration and the total duration threshold; and performing a cropping process on the sampled video frame at a start position of the initial highlight segment and the sampled video frame at an end position of the initial highlight segment according to the cropping quantity of the sampled video frame.

If there is only one initial highlight segment, it cannot be discarded, and cropping processing can be performed on the initial highlight segment. The cropping quantity of the sampled video frame to be cropped is determined according to the total duration and the total duration threshold. For example, when the total duration threshold is 3 sampled video frames, there is only one initial highlight segment, [(2, 3), (3, 5), (4, 3), (5, 2), (6, 3)], and the cropping quantity of the sampled video frame to be cropped can be determined as 2, that is, 2 sampled video frames need to be cropped. By center cropping, one sampled video frame at each end of the initial highlight segment is cropped, that is, the sampled video frame at the start position and the sampled video frame at the end position of the initial highlight segment are cropped, and the initial highlight segment [(3, 5), (4, 3), (5, 2)] is obtained, which meets the duration limit.

After the highlight segment is determined, the playback interface of the target video can be displayed according to the information of the highlight segment, and the quantity of the highlight segment and the position in the target video can be displayed.

In the above implementation, during the process of recording the target video, the target video is analyzed through at least one analysis dimension, and then the highlight segment is determined when the user plays back. Since the time-consuming operation of analysis is performed during the process of recording the target video, the highlight segment can be quickly determined during playback, thereby improving the efficiency of generating the highlight segment.

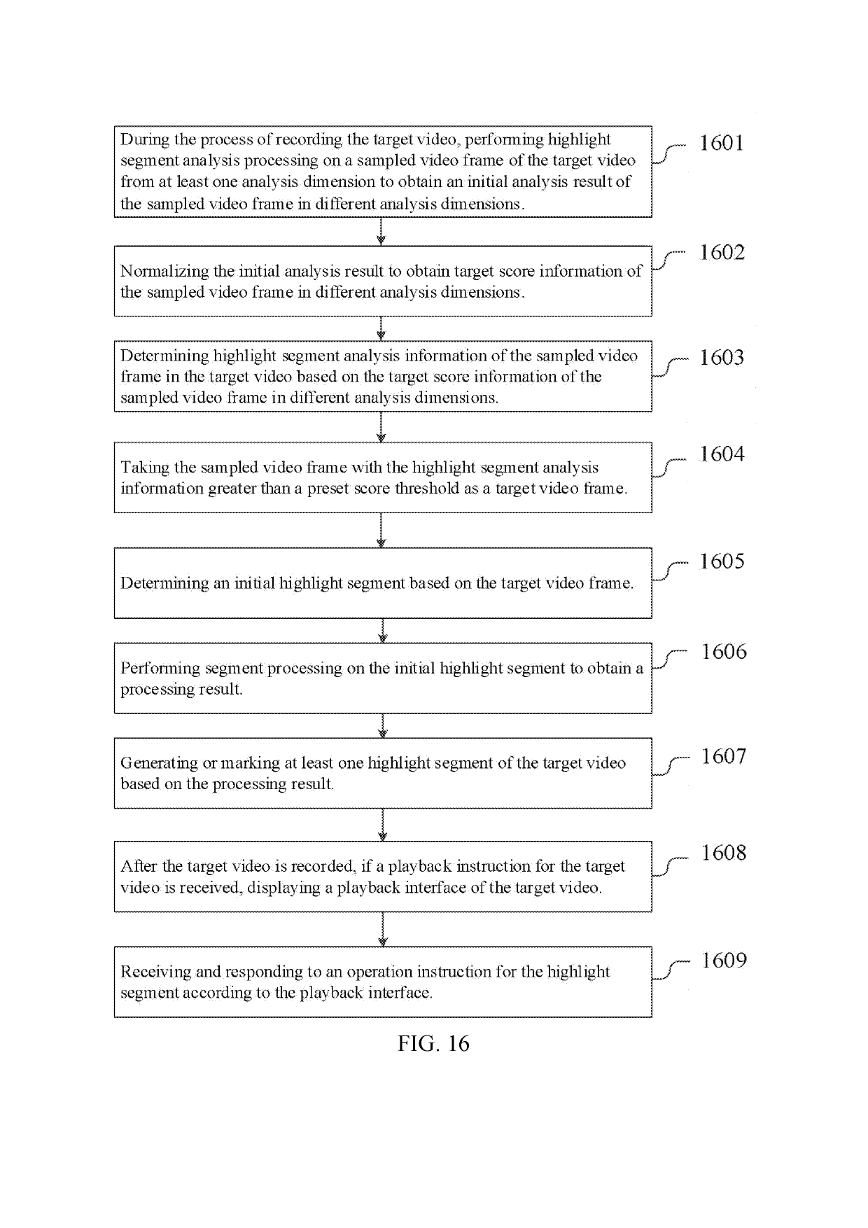

In the implementations of the present disclosure, please refer to FIG. 16, which shows a flowchart of a video processing method provided in some implementations of the present disclosure. The video processing method includes the following operations.

Operation 1601: during the process of recording the target video, performing highlight segment analysis processing on a sampled video frame of the target video from at least one analysis dimension to obtain an initial analysis result of the sampled video frame in different analysis dimensions.

Operation 1602: normalizing the initial analysis result to obtain target score information of the sampled video frame in different analysis dimensions.

Operation 1603: determining highlight segment analysis information of the sampled video frame in the target video based on the target score information of the sampled video frame in different analysis dimensions.

Operation 1604: taking the sampled video frame with the highlight segment analysis information greater than a preset score threshold as a target video frame.

Operation 1605: determining an initial highlight segment based on the target video frame.

Operation 1606: performing segment processing on the initial highlight segment to obtain a processing result.

Operation 1607: generating or marking at least one highlight segment of the target video based on the processing result.

Operation 1608: after the target video is recorded, if a playback instruction for the target video is received, displaying a playback interface of the target video.

Operation 1609: receiving and responding to an operation instruction for the highlight segment according to the playback interface.

It should be understood that although the operations in the flowcharts involved in the above implementations are sequentially displayed according to the arrows, these operations are not necessarily executed sequentially according to the order indicated by the arrows. Unless otherwise specified herein, the execution of these operations is not strictly limited in order, and these operations can be executed in other orders. Moreover, at least a portion of the operations in the flowcharts involved in the above implementations can include multiple operations or multiple stages. These operations or stages are not necessarily completed at the same time, but can be executed at different times. The execution order of these operations or stages is not necessarily sequential, but can be alternated or interleaved with at least a portion of other operations or other operations in other stages.

Based on the same concept, the implementations of the present disclosure also provide a video processing device for implementing the video processing method described above. The solution for solving the problem provided by the device is similar to the solution described in the above method. Therefore, the specific limitations in one or more implementations of the video processing device provided below can refer to the limitations of the video processing method described above and will not be repeated here.

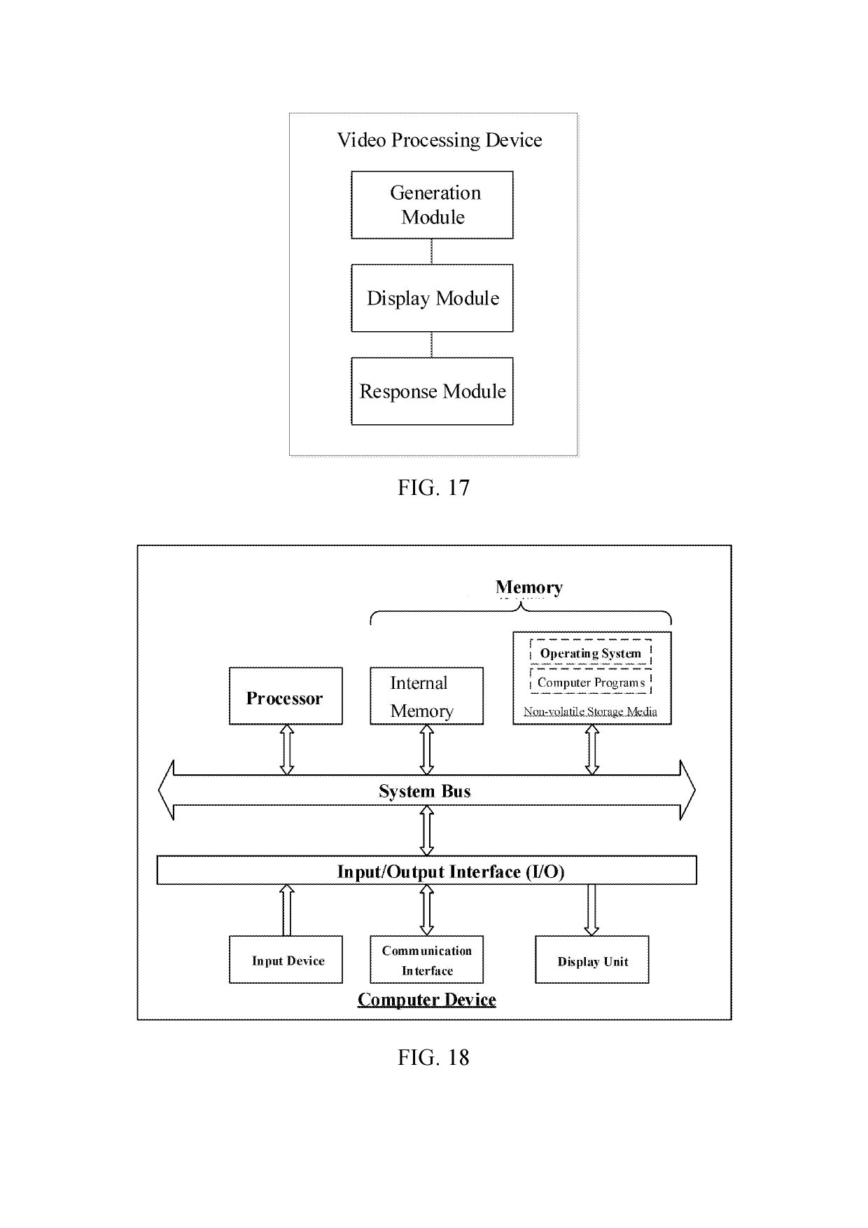

In an exemplary implementation, as shown in FIG. 17, a video processing device is provided, which is applicable to a camera device and includes: a generation module, a display module, and a response module.

An acquisition module is used to generate or mark at least one highlight segment of the target video during the process of recording the target video.

A display module is used to display a playback interface of the target video after the target video is recorded if a playback instruction for the target video is received.

A response module is used to receive and respond to an operation instruction for the highlight segment according to the playback interface.

In one implementation, the playback interface includes a highlight segment display control, and the response module is specifically used to display a highlight segment playback interface and circularly play the highlight segment based on the highlight segment playback interface if a trigger operation for the highlight segment display control is detected.

In one implementation, the highlight segment display control includes quantity indication information, and the quantity indication information indicates a quantity of highlight segments in the target video.

In one implementation, the highlight segment playback interface further includes a summary information list of the highlight segment. The summary information list includes at least one summary indication control of the highlight segment, and the summary indication control indicates summary information of the corresponding highlight segment. The response module is specifically used to display the summary indication control corresponding to the currently played highlight segment based on a target display effect during a process of circularly playing the highlight segment based on the highlight segment playback interface. The target display effect is configured to distinguish the summary indication control of the currently played highlight segment from the summary indication controls of other highlight segments.

In one implementation, the highlight segment playback interface further includes a highlight segment export control. The device further includes an export module, and the export module is used to perform an export process on the highlight segment corresponding to the selected summary indication control if a trigger operation for the highlight segment export control is detected.

In one implementation, the export module is specifically used to display an export interface if a trigger operation for the highlight segment export control is detected. The export interface includes at least one export type control. According to the export type corresponding to the selected export type control, the highlight segment corresponding to the selected summary indication control is exported.

In one implementation, the export types include a segmented export type and a merged export type. The export module is specifically used to perform an export process on the highlight segment corresponding to the selected summary indication control respectively if the export type corresponding to the selected export type control is the segmented export type; and to merge the highlight segments corresponding to the selected summary indication control and then export if the export type corresponding to the selected export type control is the merged export type.

In one implementation, the playback interface further includes a video play control. The device further includes a play module, and the play module is used to play the target video if a trigger operation for the video play control is detected, and to display a playing position interval corresponding to the highlight segment in the target video on a first progress bar of the target video during a process of playing the target video.

In one implementation, the playback interface further includes a highlight segment editing control. The device further includes a progress display module, and the progress display module is used to display a current playing progress of the target video in real time on a second progress bar of the target video if a trigger operation for the highlight segment editing control is detected during a process of playing the target video. The second progress bar is configured to display the playing position interval corresponding to the highlight segment in the target video, and a size of the second progress bar is greater than a size of the first progress bar.

In one implementation, a preset position of the second progress bar is provided with a play progress indication control. The play progress indication control indicates the current play progress of the target video. The device further includes a modification module, and the modification module is used to modify the currently played highlight segment as a non-highlight segment if the play progress indication control indicates that the current playing video segment interval is the playing position interval corresponding to the highlight segment and a highlight segment deletion operation for the play progress indication control is detected; and to generate a highlight segment based on the current playing position interval of the second progress bar if the play progress indication control indicates that the current playing video segment interval is not the playing position interval corresponding to the highlight segment and a highlight segment generation operation for the play progress indication control is detected.

In one implementation, the modification module is specifically used to generate an independent highlight segment based on the current playing position interval if there is no highlight segment in the preset interval threshold of the current playing position interval of the second progress bar.

In one implementation, the modification module is specifically used to generate a merged highlight segment based on the current playing position interval and the highlight segment in the preset interval threshold if there is a highlight segment in the preset interval threshold of the current playing position interval of the second progress bar, and the merged highlight segment includes the highlight segment in the preset interval threshold.

In one implementation, the generation module is specifically used to generate or mark at least one highlight segment of the target video based on a video recording screen corresponding to the highlight segment marking operation if a highlight segment marking operation for the target video is detected during the process of recording the target video.

In one implementation, the video recording interface of the target video includes a highlight segment marking control. The generation module is specifically used to generate or mark at least one highlight segment of the target video based on a video recording screen corresponding to the trigger operation if a trigger operation for the highlight segment marking control is detected.

In one implementation, the generation module is specifically used to generate highlight segment analysis information of the target video during the process of recording the target video, and to generate or mark at least one highlight segment of the target video according to the highlight segment analysis information.

In one implementation, the device further includes a first sending module, and the first sending module is used to send the highlight segment analysis information to a terminal, so that the terminal generates the highlight segment of the target video based on the highlight segment analysis information.

In one implementation, the device further includes a second sending module, and the second sending module is used to generate highlight segment prompt information of the target video according to the highlight segment, and to push the highlight segment prompt information to a target client of the terminal, so that the target client prompts an object of the highlight segment of the target video.

In one implementation, the device further includes a processing module, and the processing module is used to: perform highlight segment analysis processing on a sampled video frame of the target video from at least one analysis dimension during the process of recording the target video, to obtain an initial analysis result of the sampled video frame in different analysis dimensions; to normalize the initial analysis result to obtain target score information of the sampled video frame in different analysis dimensions; and to determine highlight segment analysis information of the sampled video frame in the target video based on the target score information of the sampled video frame in different analysis dimensions.

In one implementation, the display module is specifically used to: take the sampled video frame with the highlight segment analysis information greater than a preset score threshold as a target video frame; to determine an initial highlight segment based on the target video frame; to perform segment processing on the initial highlight segment to obtain a processing result; and to generate or mark at least one highlight segment of the target video based on the processing result.

In one implementation, the display module is specifically used to: calculate a time interval between each initial highlight segment; and to merge the initial highlight segments with the time interval less than a preset time threshold to obtain a highlight segment.

In one implementation, the display module is specifically used to: determine a total duration of each initial highlight segment; to determine a total duration threshold of the highlight segment based on the duration of the target video; and if the total duration is greater than the total duration threshold, to perform segment processing on the initial highlight segment, so that the total duration is not greater than the total duration threshold.

In one implementation, if there are multiple initial highlight segments, the segment processing includes a discarding process. The display module is specifically used to: determine a priority of each initial highlight segment; to determine the initial highlight segment to be discarded according to the priority; and to perform a discarding process on the initial highlight segment to be discarded.

In one implementation, if there is one initial highlight segment, the segment processing includes a cropping process. The display module is specifically used to determine a cropping quantity of the sampled video frame for the cropping process according to the total duration and the total duration threshold; and to perform a cropping process on the sampled video frame at a start position of the initial highlight segment and the sampled video frame at an end position of the initial highlight segment according to the cropping quantity of the sampled video frame.

Each module in the above video processing device can be implemented entirely or partially by software, hardware, or a combination thereof. The above modules can be embedded in or independent of the processor in the computer device in hardware form, or can be stored in the memory of the computer device in software form, so that the processor can call and execute the operations corresponding to each module described above.

Based on the same concept, the implementations of the present disclosure also provide a camera device for implementing the video processing method described above. The solution for solving the problem provided by the camera device is similar to the solution described in the above method. Therefore, the specific limitations in one or more implementations of the camera device provided below can refer to the limitations of the video processing method described above and will not be repeated here.

A camera device includes:

a camera, configured to record a target video;

at least one processor;

a display, connected/coupled to the processor; and

a memory in communication with the processor, where the memory stores one or more computer programs including instructions (e.g., executable computer instructions); when the computer instructions are executed by the processor, the processor is configured to: during a process of recording a target video by the camera, generate or mark at least one highlight segment of the target video; after the camera records the target video, if a playback instruction for the target video is received, control the display to display a playback interface of the target video; and receive and respond to an operation instruction for the highlight segment according to the playback interface.

In one implementation, the playback interface includes a highlight segment display control. When the processor receives and responds to the operation instruction for the highlight segment according to the playback interface, the processor is configured to: if a trigger operation for the highlight segment display control is detected, control the display to display a highlight segment playback interface, and control the display to circularly play the highlight segment based on the highlight segment playback interface.

In one implementation, the highlight segment display control includes quantity indication information, and the quantity indication information indicates a quantity of highlight segments in the target video.

In one implementation, the highlight segment playback interface further includes a summary information list of the highlight segment. The summary information list includes at least one summary indication control of the highlight segment, and the summary indication control indicates summary information of the corresponding highlight segment. When the processor circularly plays the highlight segment based on the highlight segment playback interface, the processor is configured to: during a process of circularly playing the highlight segment based on the highlight segment playback interface, control the display to display the summary indication control corresponding to the currently played highlight segment based on a target display effect, and the target display effect is configured to distinguish the summary indication control of the currently played highlight segment from the summary indication controls of other highlight segments.

In one implementation, the highlight segment playback interface further includes a highlight segment export control, and the processor is further configured to: if a trigger operation for the highlight segment export control is detected, perform an export process on the highlight segment corresponding to the selected summary indication control.

In one implementation, when the processor detects a trigger operation for the highlight segment export control, and the processor performs an export process on the highlight segment corresponding to the selected summary indication control, the processor is configured to: if a trigger operation for the highlight segment export control is detected, control the display to display an export interface, the export interface includes at least one export type control; and perform an export process on the highlight segment corresponding to the selected summary indication control according to an export type corresponding to the selected export type control.

In one implementation, the export types include a segmented export type and a merged export type. When the processor performs an export process on the highlight segment corresponding to the selected summary indication control according to the export type corresponding to the selected export type control, the processor is configured to: if the export type corresponding to the selected export type control is the segmented export type, perform an export process on the highlight segment corresponding to the selected summary indication control respectively; and if the export type corresponding to the selected export type control is the merged export type, merge the highlight segments corresponding to the selected summary indication control and then export the merged highlight segments.

In one implementation, the playback interface further includes a video play control, and the processor is further configured to: if a trigger operation for the video play control is detected, control the display to play the target video, and during a process of playing the target video, control the display to display a playing position interval corresponding to the highlight segment in the target video on a first progress bar of the target video.

In one implementation, the playback interface further includes a highlight segment editing control, and the processor is further configured to: if a trigger operation for the highlight segment editing control is detected during a process of playing the target video, control the display to display a current playing progress of the target video in real time on a second progress bar of the target video, where the second progress bar is configured to display the playing position interval corresponding to the highlight segment in the target video, and a size of the second progress bar is greater than a size of the first progress bar.

In one implementation, a preset position of the second progress bar is provided with a play progress indication control. The play progress indication control indicates the current play progress of the target video, and the processor is further configured to: if the play progress indication control indicates that the current playing video segment interval is the playing position interval corresponding to the highlight segment, and a highlight segment deletion operation for the play progress indication control is detected, modify the currently played highlight segment as a non-highlight segment; and if the play progress indication control indicates that the current playing video segment interval is not the playing position interval corresponding to the highlight segment, and a highlight segment generation operation for the play progress indication control is detected, generate a highlight segment based on the current playing position interval of the second progress bar.

In one implementation, when the processor generates the highlight segment based on the current playing position interval of the second progress bar, the processor is configured to: if there is no highlight segment in the preset interval threshold of the current playing position interval of the second progress bar, generate an independent highlight segment based on the current playing position interval.

In one implementation, when the processor generates the highlight segment based on the current playing position interval of the second progress bar, the processor is configured to: if there is a highlight segment in the preset interval threshold of the current playing position interval of the second progress bar, generate a merged highlight segment based on the current playing position interval and the highlight segment in the preset interval threshold, and the merged highlight segment includes the highlight segment in the preset interval threshold.

In one implementation, during the process of recording the target video by the camera, when the processor generates or marks at least one highlight segment of the target video, the processor is configured to: during the process of recording the target video by the camera, if a highlight segment marking operation for the target video is detected, generate or mark at least one highlight segment of the target video based on a video recording screen corresponding to the highlight segment marking operation.

In one implementation, the video recording interface of the target video includes a highlight segment marking control. When the processor detects the highlight segment marking operation for the target video, and the processor generates or marks at least one highlight segment of the target video based on the video recording screen corresponding to the highlight segment marking operation, the processor is configured to: if a trigger operation for the highlight segment marking control is detected, generate or mark at least one highlight segment of the target video based on a video recording screen corresponding to the trigger operation.

In one implementation, during the process of recording the target video by the camera, when the processor generates or marks at least one highlight segment of the target video, the processor is configured to: during the process of recording the target video by the camera, generate highlight segment analysis information of the target video; and generate or mark at least one highlight segment of the target video according to the highlight segment analysis information.

In one implementation, the processor is further configured to: send the highlight segment analysis information to a terminal, so that the terminal generates the highlight segment of the target video based on the highlight segment analysis information.

In one implementation, the processor is further configured to: generate highlight segment prompt information of the target video according to the highlight segment; and push the highlight segment prompt information to a target client of the terminal, so that the target client prompts an object of the highlight segment of the target video.

In one implementation, during the process of recording the target video by the camera, when the processor generates the highlight segment analysis information of the target video, the processor is configured to: during the process of recording the target video by the camera, perform highlight segment analysis processing on a sampled video frame of the target video from at least one analysis dimension to obtain an initial analysis result of the sampled video frame in different analysis dimensions; normalize the initial analysis result to obtain target score information of the sampled video frame in different analysis dimensions; and determine highlight segment analysis information of the sampled video frame in the target video based on the target score information of the sampled video frame in different analysis dimensions.

In one implementation, when the processor generates or marks at least one highlight segment of the target video according to the highlight segment analysis information, the processor is configured to: take the sampled video frame with the highlight segment analysis information greater than a preset score threshold as a target video frame; determine an initial highlight segment based on the target video frame; perform segment processing on the initial highlight segment to obtain a processing result; and generate or mark at least one highlight segment of the target video based on the processing result.

In one implementation, when the processor performs segment processing on the initial highlight segment, the processor is configured to: calculate a time interval between each initial highlight segment; and merge the initial highlight segments with the time interval less than a preset time threshold.

In one implementation, when the processor performs segment processing on the initial highlight segment, the processor is configured to: determine a total duration of each initial highlight segment; determine a total duration threshold of the highlight segment based on the duration of the target video; and if the total duration is greater than the total duration threshold, perform segment processing on the initial highlight segment, so that the total duration is not greater than the total duration threshold.

In one implementation, if there are multiple initial highlight segments, the segment processing includes a discarding process. When the processor performs segment processing on the initial highlight segment to make the total duration not greater than the total duration threshold, the processor is configured to: determine a priority of each initial highlight segment; determine the initial highlight segment to be discarded according to the priority; and perform a discarding process on the initial highlight segment to be discarded.

In one implementation, if there is one initial highlight segment, the segment processing includes a cropping process. When the processor performs segment processing on the initial highlight segment to make the total duration not greater than the total duration threshold, the processor is configured to: determine a cropping quantity of the sampled video frame for the cropping process according to the total duration and the total duration threshold; and perform a cropping process on the sampled video frame at a start position of the initial highlight segment and the sampled video frame at an end position of the initial highlight segment according to the cropping quantity of the sampled video frame.

Based on the same concept, the implementations of the present disclosure also provide an image processing device for implementing the video processing method described above. The solution for solving the problem provided by the image processing device is similar to the solution described in the above method. Therefore, the specific limitations in one or more implementations of the image processing device provided below can refer to the limitations of the video processing method described above and will not be repeated here.

An image processing device, the image processing device is in communication connection with a camera device, includes:

one or more processors;

a display, connected/coupled to the processor; and

a memory in communication with the processor, where the memory stores one or more computer programs including instructions (e.g., executable computer instructions); when the computer instructions are executed by the processor, the processor is configured to: obtain a target video recorded by the camera device, and the target video includes at least one highlight segment generated or marked during a process of recording the target video; if a playback instruction for the target video is received, control the display to display a playback interface of the target video; and receive and respond to an operation instruction for the highlight segment according to the playback interface.

The image processing device can include a terminal, and a target client program can be deployed on the terminal. The terminal obtains the target video recorded by the camera device. If a playback instruction for the target video is received, the terminal controls the display to display a playback interface of the target video, and receives and responds to an operation instruction for the highlight segment according to the playback interface. The communication connection can be via a network, card reader, WIFI, or Universal Serial Bus (USB), or other wired or wireless means.

In one implementation, the playback interface includes a highlight segment display control. When the processor receives and responds to the operation instruction for the highlight segment according to the playback interface, the processor is configured to: if a trigger operation for the highlight segment display control is detected, control the display to display a highlight segment playback interface, and circularly play the highlight segment based on the highlight segment playback interface.

In one implementation, the highlight segment display control includes quantity indication information, and the quantity indication information indicates a quantity of highlight segments in the target video.

In one implementation, the highlight segment playback interface further includes a summary information list of the highlight segment. The summary information list includes at least one summary indication control of the highlight segment, and the summary indication control indicates summary information of the corresponding highlight segment. When the processor circularly plays the highlight segment based on the highlight segment playback interface, the processor is configured to: during a process of circularly playing the highlight segment based on the highlight segment playback interface, control the display to display the summary indication control corresponding to the currently played highlight segment based on a target display effect, and the target display effect is configured to distinguish the summary indication control of the currently played highlight segment from the summary indication controls of other highlight segments.

In one implementation, the highlight segment playback interface further includes a highlight segment export control, and the processor is further configured to: if a trigger operation for the highlight segment export control is detected, perform an export process on the highlight segment corresponding to the selected summary indication control.

In one implementation, when the processor detects a trigger operation for the highlight segment export control, and the processor performs an export process on the highlight segment corresponding to the selected summary indication control, the processor is configured to: if a trigger operation for the highlight segment export control is detected, control the display to display an export interface, where the export interface includes at least one export type control; and perform an export process on the highlight segment corresponding to the selected summary indication control according to an export type corresponding to the selected export type control.

In one implementation, the export types include a segmented export type and a merged export type. When the processor performs an export process on the highlight segment corresponding to the selected summary indication control according to the export type corresponding to the selected export type control, the processor is configured to: if the export type corresponding to the selected export type control is the segmented export type, perform an export process on the highlight segment corresponding to the selected summary indication control respectively; and if the export type corresponding to the selected export type control is the merged export type, merge the highlight segments corresponding to the selected summary indication control and then export the merged highlight segments.

In one implementation, the playback interface further includes a video play control, and the processor is further configured to: if a trigger operation for the video play control is detected, control the display to play the target video, and during a process of playing the target video, control the display to display a playing position interval corresponding to the highlight segment in the target video on a first progress bar of the target video.

In one implementation, the playback interface further includes a highlight segment editing control, and the processor is further configured to: if a trigger operation for the highlight segment editing control is detected during a process of playing the target video, control the display to display a current playing progress of the target video in real time on a second progress bar of the target video, where the second progress bar is configured to display the playing position interval corresponding to the highlight segment in the target video, and a size of the second progress bar is greater than a size of the first progress bar.

In one implementation, a preset position of the second progress bar is provided with a play progress indication control. The play progress indication control indicates the current play progress of the target video, and the processor is further configured to: if the play progress indication control indicates that the current playing video segment interval is the playing position interval corresponding to the highlight segment, and a highlight segment deletion operation for the play progress indication control is detected, modify the currently played highlight segment as a non-highlight segment; and if the play progress indication control indicates that the current playing video segment interval is not the playing position interval corresponding to the highlight segment, and a highlight segment generation operation for the play progress indication control is detected, generate a highlight segment based on the current playing position interval of the second progress bar.

In one implementation, when the processor generates the highlight segment based on the current playing position interval of the second progress bar, the processor is configured to: if there is no highlight segment in the preset interval threshold of the current playing position interval of the second progress bar, generate an independent highlight segment based on the current playing position interval.

In one implementation, when the processor generates the highlight segment based on the current playing position interval of the second progress bar, the processor is configured to: if there is a highlight segment in the preset interval threshold of the current playing position interval of the second progress bar, generate a merged highlight segment based on the current playing position interval and the highlight segment in the preset interval threshold, where the merged highlight segment includes the highlight segment in the preset interval threshold.

In an exemplary implementation, a computer device is provided, which can be a terminal, and its internal structure diagram can be as shown in FIG. 18. The computer device includes a processor, a memory, an input/output interface, a communication interface, a display unit, and an input device. The processor, memory, and input/output interface are connected or coupled through a system bus, and the communication interface, display unit, and input device are connected to the system bus through the input/output interface. The processor of the computer device is used to provide computing and control capabilities. The memory of the computer device includes a non-volatile storage medium and an internal memory. The non-volatile storage medium stores the operating system and computer programs. The internal memory provides an environment for running the operating system and computer programs in the non-volatile storage medium. The input/output interface of the computer device is used to exchange information between the processor and external devices. The communication interface of the computer device is used to communicate with external terminals in a wired or wireless manner. The wireless manner can be implemented through WIFI, mobile cellular network, NFC (Near Field Communication), or other technologies. When the computer program is executed by the processor, a video processing method can be implemented. The display unit of the computer device is used to form a visually visible screen, which can be a display screen, a projection device, or a virtual reality imaging device. The display screen can be a liquid crystal display or an electronic ink display. The input device of the computer device can be a touch layer covering the display screen, or keys, a trackball, or a touchpad provided on the housing of the computer device, or an external keyboard, touchpad, or mouse, etc.

Those skilled in the art can understand that the structure shown in FIG. 18 is only a block diagram of the part of the structure related to the solution of the present disclosure, and does not constitute a limitation on the computer device to which the solution of the present disclosure is applied. The specific computer device can include more or fewer components than those shown in the figure, or combine some components, or have different component arrangements.

In an exemplary implementation, a computer device is provided, including a memory and a processor. The memory stores a computer program, and the processor implements the operations in the above method implementations when executing the computer program.

In one implementation, a computer-readable storage medium is provided, on which a computer program is stored. When the computer program is executed by a processor, the operations in the above method implementations are implemented.

In one implementation, a computer program product is provided, including a computer program. When the computer program is executed by a processor, the operations in the above method implementations are implemented.

It should be noted that the user information (including but not limited to user device information, user personal information, etc.) and data (including but not limited to data for analysis, stored data, displayed data, etc.) involved in the present disclosure are all information and data authorized by the user or fully authorized by all parties, and the collection, use, and processing of relevant data need to comply with relevant regulations.

Those of ordinary skill in the art can understand that all or part of the processes in the above method implementations can be completed by instructing related hardware through a computer program. The computer program can be stored in a non-volatile computer-readable storage medium. When the computer program is executed, it can include the processes in the method implementations described above. Any reference to memory, database, or other media used in some implementations provided in the present disclosure can include at least one of non-volatile and volatile memory. The non-volatile memory can include Read-Only Memory (ROM), tape, floppy disk, flash memory, optical storage, high-density embedded non-volatile memory, resistive random access memory (ReRAM), magnetoresistive random access memory (MRAM), ferroelectric random access memory (FRAM), phase change memory (PCM), graphene memory, etc. The volatile memory can include Random Access Memory (RAM) or external cache, etc. By way of illustration and not limitation, RAM can be in various forms, such as Static Random Access Memory (SRAM) or Dynamic Random Access Memory (DRAM), etc. The database involved in some implementations provided in the present disclosure can include at least one of relational databases and non-relational databases. The non-relational database can include a blockchain-based distributed database, etc., but is not limited thereto. The processor involved in some implementations provided in the present disclosure can be a general-purpose processor, central processing unit, graphics processor, digital signal processor, programmable logic device, quantum computing-based data processing logic device, etc., but is not limited thereto.

The technical features of the above implementations can be combined arbitrarily. For the sake of brevity, all possible combinations of the technical features in the above implementations are not described. However, as long as the combination of these technical features does not conflict, it should be considered to be within the scope described in this specification.

The above implementations only express several implementations of the present disclosure, and their descriptions are relatively specific and detailed, but they should not be understood as limiting the scope of the present disclosure. It should be pointed out that for those of ordinary skill in the art, several modifications and improvements can be made without departing from the concept of the present disclosure, and these all belong to the protection scope of the present disclosure. Therefore, the protection scope of the present disclosure should be subject to the claims appended.

What is claimed is:

1. A camera device, comprising:
a camera, configured to record a target video;
a processor;
a display, coupled to the processor; and
a memory in communication with the processor, wherein the memory is configured to store computer instructions, and when the computer instructions are executed by the processor, the processor is configured to:
during a recording of a target video by the camera, generate or mark at least one highlight segment of the target video;
after the target video is recorded by the camera, in response to receiving a playback instruction for the target video, control the display to display a playback interface of the target video; and
receive and respond to an operation instruction for the at least one highlight segment according to the playback interface.

2. The camera device according to claim 1, wherein:
the playback interface comprises a highlight segment display control, and when the processor receives and responds to the operation instruction for the at least one highlight segment according to the playback interface, the processor is configured to:
in response to detecting a trigger operation for the highlight segment display control, control the display to display a highlight segment playback interface, and control the display to play the at least one highlight segment in a loop according to the highlight segment playback interface.

3. The camera device according to claim 2, wherein the highlight segment display control comprises quantity indication information, and the quantity indication information indicates a quantity of highlight segments in the target video.

4. The camera device according to claim 2, wherein the highlight segment playback interface further comprises a summary information list of the at least one highlight segment, the summary information list comprises at least one summary indication control of the at least one highlight segment, the summary indication control indicates summary information of the corresponding highlight segment, and when the processor circularly plays the at least one highlight segment based on the highlight segment playback interface, the processor is configured to:
during a process of circularly playing the at least one highlight segment based on the highlight segment playback interface, control the display to display the summary indication control corresponding to the currently played highlight segment based on a target display effect, wherein the target display effect is configured to distinguish the summary indication control of the currently played highlight segment from the summary indication controls of other highlight segments.

5. The camera device according to claim 4, wherein the highlight segment playback interface further comprises a highlight segment export control, and the processor is further configured to:
in response to detecting a trigger operation for the highlight segment export control, perform an export process on the highlight segment corresponding to the selected summary indication control.

6. The camera device according to claim 5, wherein when the processor detects a trigger operation for the highlight segment export control, and the processor performs an export process on the highlight segment corresponding to the selected summary indication control, the processor is configured to:
in response to detecting a trigger operation for the highlight segment export control, control the display to display an export interface, wherein the export interface comprises at least one export type control; and
perform an export process on the highlight segment corresponding to the selected summary indication control according to an export type corresponding to the selected export type control.

7. The camera device according to claim 6, wherein the export types comprise a segmented export type and a merged export type, and when the processor performs an export process on the highlight segment corresponding to the selected summary indication control according to the export type corresponding to the selected export type control, the processor is configured to:
in response to the export type corresponding to the selected export type control being the segmented export type, perform an export process on the highlight segment corresponding to the selected summary indication control respectively; and
in response to the export type corresponding to the selected export type control being the merged export type, merge the highlight segments corresponding to the selected summary indication control and then export the merged highlight segments.

8. The camera device according to claim 1, wherein:
the playback interface further comprises a video play control, and the processor is further configured to:
in response to detecting a trigger operation for the video play control, control the display to play the target video, and during playing the target video, control the display to display a playing position interval corresponding to the at least one highlight segment in the target video on a first progress bar of the target video.

9. The camera device according to claim 8, wherein the playback interface further comprises a highlight segment editing control, and the processor is further configured to:
in response to detecting a trigger operation for the highlight segment editing control during a process of playing the target video, control the display to display a current playing progress of the target video in real time on a second progress bar of the target video, wherein the second progress bar is configured to display the playing position interval corresponding to the highlight segment in the target video, and a size of the second progress bar is greater than a size of the first progress bar.

10. The camera device according to claim 9, wherein a preset position of the second progress bar is provided with a play progress indication control, the play progress indication control indicates the current play progress of the target video, and the processor is further configured to:
in response to the play progress indication control indicating that the current playing video segment interval is the playing position interval corresponding to the highlight segment, and detecting a highlight segment deletion operation for the play progress indication control, modify the currently played highlight segment as a non-highlight segment; and
in response to the play progress indication control indicating that the current playing video segment interval is not the playing position interval corresponding to the highlight segment, and detecting a highlight segment generation operation for the play progress indication control, generate a highlight segment based on the current playing position interval of the second progress bar.

11. The camera device according to claim 10, wherein when the processor generates the highlight segment based on the current playing position interval of the second progress bar, the processor is configured to:
in response to there being no highlight segment in a preset interval threshold of the current playing position interval of the second progress bar, generate an independent highlight segment based on the current playing position interval.

12. The camera device according to claim 10, wherein when the processor generates the highlight segment based on the current playing position interval of the second progress bar, the processor is configured to:
in response to there being a highlight segment in the preset interval threshold of the current playing position interval of the second progress bar, generate a merged highlight segment based on the current playing position interval and the highlight segment in the preset interval threshold, wherein the merged highlight segment comprises the highlight segment in the preset interval threshold.

13. The camera device according to claim 1, wherein:
when the processor generates or marks the at least one highlight segment of the target video during the recording of the target video by the camera, the processor is configured to:
during the recording of the target video by the camera, in response to detecting a highlight segment marking operation for the target video, generate or mark the at least one highlight segment of the target video according to a video recording screen corresponding to the highlight segment marking operation.

14. The camera device according to claim 13, wherein a video recording interface of the target video comprises a highlight segment marking control, and when the processor detects the highlight segment marking operation for the target video, and the processor generates or marks at least one highlight segment of the target video based on the video recording screen corresponding to the highlight segment marking operation, the processor is configured to:
in response to detecting a trigger operation for the highlight segment marking control, generate or mark at least one highlight segment of the target video based on a video recording screen corresponding to the trigger operation.

15. The camera device according to claim 1, wherein:
when the processor generates or marks the at least one highlight segment of the target video during the recording of the target video by the camera, the processor is configured to:
during the recording of the target video by the camera, generate highlight segment analysis information of the target video; and
generate or mark the at least one highlight segment of the target video according to the highlight segment analysis information.

16. An image processing device, wherein the image processing device is in communication connection with a camera device, comprising:
a processor;
a display, coupled to the processor; and
a memory in communication with the processor, wherein the memory stores computer instructions, and when the computer instructions are executed by the processor, the processor is configured to:
obtain a target video recorded by the camera device, wherein the target video comprises at least one highlight segment generated or marked during a recording of the target video;
in response to detecting a playback instruction for the target video, control the display to display a playback interface of the target video; and
receive and respond to an operation instruction for the at least one highlight segment according to the playback interface.

17. The image processing device according to claim 16, wherein:
the playback interface comprises a highlight segment display control, and when the processor receives and responds to the operation instruction for the at least one highlight segment according to the playback interface, the processor is configured to:
in response to detecting a trigger operation for the highlight segment display control, control the display to display a highlight segment playback interface, and play the highlight segment in a loop according to the highlight segment playback interface.

18. The image processing device according to claim 17, wherein:
the highlight segment display control comprises quantity indication information, and the quantity indication information is configured to indicate a quantity of the at least one highlight segments of the target video.

19. The image processing device according to claim 18, wherein:
the highlight segment playback interface further comprises a summary information list of the at least one highlight segment, the summary information list comprises at least one summary indication control of the at least one highlight segment, and the at least one summary indication control is configured to indicate summary information of a corresponding highlight segment; and
when the processor plays the at least one highlight segment in a loop according to the highlight segment playback interface, the processor is configured to:
during playing the at least one highlight segment in a loop according to the highlight segment playback interface, control the display to display the summary indication control corresponding to a currently played highlight segment according to a target display effect, wherein the target display effect is configured to distinguish the summary indication control of the currently played highlight segment from a summary indication control of another highlight segment of the at least one highlight segment.

20. The image processing device according to claim 16, wherein:
the playback interface further comprises a video play control, the processor being further configured to:
in response to detecting a trigger operation for the video play control, control the display to play the target video, and during playing the target video, control the display to display a playing position interval corresponding to the at least one highlight segment in the target video on a first progress bar of the target video.
